(19) United States
(12) Patent Application Publication
(10) Pub. No.: US 2005/0265280 A1
(43) Pub. Date: Dec. 1, 2005

(54) OFDM symbol transmission method and apparatus for providing sector diversity in a mobile communication system, and a system using the same

(75) Inventors: Hee-Jin Roh, Suwon-si (KR); Min-Goo Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/136,460

(22) Filed: May 25, 2005

(30) Foreign Application Priority Data
May 25, 2004 (KR) 2004-37578
May 25, 2004 (KR) 2004-37581
May 25, 2004 (KR) 2004-37582
May 25, 2004 (KR) 2004-37583

(51) Int. Cl. H04J 11/00; H04Q 7/00

(52) U.S. Cl. 370/328; 370/208

(57) ABSTRACT

A method and apparatus for transmitting an orthogonal frequency division multiplexing (OFDM) symbol from a base station to a mobile station in a wireless mobile communication system with a multicell/multisector structure formed by a plurality of base stations. The base station receives a plurality of complex symbols to be transmitted to the mobile station. The base station performs space-time coding (STC) on the plurality of complex symbols and selects the STC-coded symbols such that different space-time code streams are transmitted to adjacent sectors among sectors formed by the base station and other base stations. In addition, a selection pattern of the space-time code streams is updated such that it is circulated every predetermined time period, thereby providing uniform sector diversity for all mobile stations located in a sector/cell boundary.

### PRIORITY

This application claims the benefit under 35 U.S.C. §119(a) of an application entitled “Method and Apparatus for Transmitting Orthogonal Frequency Division Multiplexing Symbols in a Mobile Communication System with Multicell/Multisector Structure, and System Using the Same” filed in the Korean Intellectual Property Office on May 25, 2004 and assigned Serial No. 2004-37582, an application entitled “OFDM Symbol Transmission Method and Apparatus for Providing Sector Diversity in a Mobile Communication System, and System Using the Same” filed in the Korean Intellectual Property Office on May 25, 2004 and assigned Serial No. 2004-37581, an application entitled “OFDM Symbol Transmission Method and Apparatus for Providing Sector Diversity in a Mobile Communication System, and System Using the Same” filed in the Korean Intellectual Property Office on May 25, 2004 and assigned Serial No. 2004-37583, and an application entitled “Apparatus and Method for Providing Diversity for Broadcast Service in a Mobile Communication System” filed in the Korean Intellectual Property Office on May 25, 2004 and assigned Serial No. 2004-37578, the entire contents of all of which are incorporated herein by reference.

### BACKGROUND OF THE INVENTION

1. Field of the Invention

The present invention relates generally to a method and apparatus for transmitting Orthogonal Frequency Division Multiplexing (OFDM) symbols in an OFDM mobile communication system. In particular, the present invention relates to an OFDM symbol transmission method and apparatus for providing sector diversity in a mobile communication system, and a system using the same.

2. Description of the Related Art

Mobile communication systems were first developed to provide voice service. A Code Division Multiple Access (CDMA) mobile communication system is a typical example of a mobile communication system. Herein, the mobile communication system, unless stated otherwise, refers to the CDMA mobile communication system. The mobile communication system has evolved from early mobile communication systems that supported only voice service into an advanced mobile communication system supporting a low-speed data service. In the near future, the mobile communication system will evolve into a system supporting only a high-speed data service and a system supporting both the high-speed data service and voice service.

The mobile communication system with data service has been developing into a multipurpose, multifunctional system for providing various services, for example, Internet service, mobile image service, banking service, etc. Recently, many attempts have been made to enable a user to enjoy a broadcast service with a mobile terminal.

The conventional over-the-air broadcasting system will first be described below. The conventional over-the-air broadcasting service system is classified into either a Phase Alternation by Line (PAL) system adopted in Europe as a standard or a National Television Systems Committee (NSTC) system adopted in North America as a standard. The over-the-air broadcasting system transmits different broadcast data through different frequency bands, and therefore has a limitation on increasing its data rate. However, users are demanding a high-quality broadcast service, for example, a high density television (HDTV) broadcast service or a HDTV broadcast service combined with a multi-channel audio service. In order to meet user demand, it is necessary to increase a data rate for the broadcast service.

A wireless communication system employing an Orthogonal Frequency Division Multiplexing (OFDM) transmission scheme is a typical example of the wireless mobile communication system employing a multicarrier transmission scheme to provide a high data rate. The OFDM transmission scheme converts a serial input symbol stream into parallel symbols and modulates the parallel symbols with multiple orthogonal subcarriers prior to transmission, and has become popular since the early 1990s with the development of Very Large Scale Integration (VLSI) technology.

The OFDM transmission scheme modulates data using multiple subcarriers, each of which maintains orthogonality with the other subcarriers. Therefore, compared with the conventional single-carrier modulation scheme, the OFDM transmission scheme exhibits a robust characteristic against a frequency selective multipath fading channel.

Due to this characteristic, from a mobile station's point of view, the frequency selective multipath fading channel becomes a frequency selective channel for the full frequency band in which data is transmitted. However, the frequency selective multipath fading channel becomes a frequency nonselective channel for each subcarrier band in which data is not transmitted. Therefore, the mobile station can perform channel compensation on the frequency selective multipath fading channel through a simple channel equalization process.

In addition, the OFDM transmission scheme attaches a cyclic prefix symbol (CP) obtained by copying a rear part of each OFDM symbol to the header of the OFDM symbol prior to transmission, thereby removing intersymbol interference (ISI) from a previous symbol. This robust characteristic to protect against the multipath fading channel enables the OFDM transmission scheme to be suitable for high-speed wideband communication.

Therefore, in a broadcast service standard for the wireless mobile communication system, the OFDM transmission scheme attracts attention as a transmission scheme capable of guaranteeing high reception quality and high-speed transmission/reception. The broadcast service standard adopting the OFDM transmission scheme comprises Digital Audio Broadcasting (DAB) for European wireless radio broadcasting, and Terrestrial Digital Video Broadcasting (DVB-T) which is a terrestrial High Definition Television (HDTV).

FIG. 1 is a diagram illustrating a structure of the conventional wireless mobile communication system employing the OFDM scheme. Referring to FIG. 1, a modulator 111 in each of base stations (BSs) 110₁ to 110_{M} modulates data to be transmitted to a mobile station (MS) 130 with a predetermined modulation scheme, and outputs the modulated data to an inverse fast Fourier transform block (IFFT) 113. The IFFT 113 performs an inverse fast Fourier transform on the modulated data to convert the modulated data into time-domain data, and outputs the IFFT-processed data to a CP attacher 130. The CP attacher 130 attaches a cyclic prefix symbol (CP) to the IFFT-processed data and outputs an OFDM symbol. The OFDM symbol is transmitted to a wireless network via an antenna 117.

The mobile station 130 receives an OFDM symbol received at a sector where it is located, via an antenna 131. In the mobile station 130, a CP remover 133 detaches a CP from the received OFDM symbol, and delivers the CP-detached OFDM symbol to a fast Fourier transform block (FFT) 135. The FFT 135 performs fast Fourier transform on the OFDM symbol to convert the OFDM symbol into a frequency-domain signal, and outputs the FFT-processed OFDM symbol to a demodulator 137. The demodulator 137 demodulates the FFT-processed OFDM symbol according to a predetermined demodulation scheme.

As described above, the general OFDM system can be simply implemented using the IFFT 113 and the FFT 135 such that data is transmitted and received with multiple subcarriers.

In the OFDM system with a multicell/multisector structure, when multiple base stations transmit data using the same subcarrier and different data is transmitted through the subcarrier, interference occurs between transmission data in a boundary of each sector, causing major performance deterioration.

In this context, an Orthogonal Frequency Division Multiple Access (OFDMA) scheme, which is a multiple access scheme capable of accommodating a plurality of users taking both time and frequency into consideration, is preferred for a system having the interference problem in the sector boundary, such as a Wireless Local Area Network (WLAN) system and a Wireless Metropolitan Area Network (WMAN) system. Currently, standards for IEEE 802.16d and 2.3 GHz portable Internet, also known as Wireless Broadband Internet (WiBro), fully consider adopting the OFDMA scheme.

In the conventional WLAN/WMAN system, when different data from base stations is transmitted through the same subcarrier, data received from undesired base stations in a sector boundary serves as an interference component to data X[k] transmitted from a desired base station as shown in Equation (1) below:

$$Y [ k ] = H [ k ] X [ k ] + ( {\sum }_{i = 2}^{L} {H}_{i} [ k ] ) {X}_{i} [ k ] + W [ k ] \qquad ( 1 )$$

where Y[k] denotes a signal received at a mobile station through a k^{th} subcarrier, Hᵢ[k] denotes a channel component of a signal received from an i^{th} base station through a k^{th} subcarrier, W[k] denotes a noise component of a k^{th} subcarrier, and L denotes the number of sectors around the mobile station.

In Equation (1), a second term serves as an intersector interference component for a first term indicating the data that the mobile station desires to receive. Because the intersector interference component deteriorates bit error rate (BER) performance, it is preferable to use the OFDMA scheme rather than the OFDM scheme in reducing a mean interference component by the multiple access scheme.

When a broadcast system employing the OFDM transmission scheme uses a single frequency network (SFN) and a plurality of base stations 110 transmit the same data as shown in FIG. 1, data transmitted from the different base stations is received at the mobile station 130 as the same data with a mere difference in reception delay and channel gain. Therefore, no interference component occurs in the sector boundary unlike in the case where different data is transmitted from the base stations.

Equation (2) shows an FFT output signal of the mobile station 130 on the assumption that the same data X[k] is transmitted from the different base stations through a k^{th} subcarrier:

$$Y [ k ] = ( {\sum }_{i = 1}^{L} {H}_{i} [ k ] ) {X}_{i} [ k ] + W [ k ] \qquad ( 2 )$$

In Equation (2), because a signal received from a neighboring base station corresponds to the same transmission signal X[k] transmitted through a channel Hᵢ[k], no intersector interference occurs unlike in Equation (1). In particular, when a mobile station is located in a sector boundary, signals received from the base stations are similar to each other in strength in Equation (2), increasing the number L of sectors around the mobile station. However, when the mobile station is located in the vicinity of a base station, a value of the L is decreased.

As can be understood from the received signal of Equation (2), in the conventional technology, channel components from the base stations to the mobile station in the FFT output signal of the mobile station are shown in the combined form rather than being separated. Therefore, a receiver of the mobile station cannot use diversity combining because it cannot distinguish the channel components transmitted from the base stations, making it difficult to sufficiently acquire a diversity gain between sectors, especially when the mobile station is located in the sector boundary.

### SUMMARY OF THE INVENTION

It is, therefore, an object of the present invention to provide an orthogonal frequency division multiplexing (OFDM) symbol transmission method and apparatus for providing improved sector diversity in a mobile communication system, and a system using the same.

It is another object of the present invention to provide an OFDM symbol transmission method and apparatus for providing uniform sector diversity in a mobile communication system employing an OFDM transmission scheme, and a system using the same.

According to one aspect of the present invention, there is provided a method for transmitting by a base station an orthogonal frequency division multiplexing (OFDM) symbol to a mobile station in a wireless mobile communication system with a multicell/multisector structure formed by a plurality of base stations. The method comprises the steps of receiving a plurality of complex symbols to be transmitted to the mobile station; and space-time coding (STC) the plurality of complex symbols and selecting the STC-coded symbols such that different space-time code streams are transmitted to at least one adjacent sector among sectors formed by the base station and other base stations.

According to another aspect of the present invention, there is provided a base station apparatus for transmitting an orthogonal frequency division multiplexing (OFDM) symbol to a mobile station in a wireless mobile communication system with a multicell/multisector structure formed by a plurality of base stations. The apparatus comprises a space-time coding (STC) encoder for space-time coding a plurality of received complex symbols into a plurality of different space-time code streams; and a selector for selecting one of the plurality of space-time code streams such that different space-time code streams are transmitted to at least one adjacent sector among sectors formed by the base station and/or other base stations, and a transmitter for transmitting the space-time code stream output from the selector to a wireless network.

According to further one aspect of the present invention, there is provided an orthogonal frequency division multiplexing (OFDM) system with a multicell/multisector structure. The system comprises a plurality of base stations each comprising a space-time coding (STC) encoder for space-time coding a plurality of received complex symbols into a plurality of different space-time code streams, and a selector for selecting one of the plurality of space-time code streams such that different space-time code streams are transmitted to at least one adjacent sector; and at least one mobile station for receiving OFDM symbols transmitted from the plurality of base stations and performing diversity combing on the received OFDM symbols.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a conventional wireless mobile communication system employing an orthogonal frequency division multiplexing (OFDM) scheme;

FIG. 2 is a diagram illustrating a space-time coding scheme applicable to the present invention;

FIG. 3 is a block diagram illustrating a structure of a wireless mobile communication system to which an OFDM symbol transmission method according to a first embodiment of the present invention is applied;

FIGS. 4A and 4B are diagrams illustrating different examples of space-time code streams output from the space time coding (STC) encoder of FIG. 3;

FIG. 5 is a diagram illustrating an example of a sector structure applicable to the first embodiment of the present invention;

FIG. 6 is a flowchart for a description of an OFDM symbol transmission method based on an SFC-OFDM modulation scheme according to the first embodiment of the present invention;

FIG. 7 is a diagram illustrating a process of transmitting space-time code streams in the method of FIG. 6;

FIG. 8 is a flowchart for a description of an OFDM symbol transmission method based on an STC-OFDM modulation scheme according to the first embodiment of the present invention;

FIG. 9 is a diagram illustrating a process of transmitting space-time code streams in the method of FIG. 8;

FIG. 10 is a block diagram of a mobile communication system to which an OFDM symbol transmission method according to a second embodiment of the present invention is applied;

FIG. 11 is a circuit diagram for a description of an operation of the STC encoder illustrated in FIG. 10;

FIG. 12 is a diagram illustrating an example of a sector structure applicable to the second embodiment of the present invention;

FIG. 13 is a diagram for a description of an SFC-OFDM modulation scheme according to the second embodiment of the present invention;

FIG. 14 is a diagram for a description of an STC-OFDM modulation scheme according to the second embodiment of the present invention;

FIG. 15 is a diagram for a description of an SFTC-OFDM modulation scheme according to the second embodiment of the present invention;

FIG. 16 is a block diagram illustrating a structure of a wireless mobile communication system to which an OFDM symbol transmission method according to a third embodiment of the present invention is applied;

FIG. 17 is a diagram illustrating an update period and a transmission pattern of space-time code streams transmitted from a base station to a mobile station according to the third embodiment of the present invention;

FIG. 18 is a flowchart illustrating an OFDM symbol transmission method according to the third embodiment of the present invention

FIGS. 19 to 21 are diagrams illustrating a per-sector space-time code stream arrangement method according to the third embodiment of the present invention;

FIGS. 22 to 24 are diagrams illustrating a per-cell space-time code stream arrangement method according to the third embodiment of the present invention;

FIG. 25 is a flowchart illustrating an OFDM symbol transmission method based on a space frequency coding (SFC)-OFDM scheme according to the third embodiment of the present invention;

FIG. 26 is a diagram illustrating a process of transmitting space-time code streams in the method of FIG. 25 according to an embodiment of the present invention;

FIG. 27 is a flowchart illustrating an OFDM symbol transmission method based on an STC-OFDM scheme according to the third embodiment of the present invention; and

FIG. 28 is a diagram illustrating a process of transmitting space-time code streams in the method of FIG. 27 according to an embodiment of the present invention.

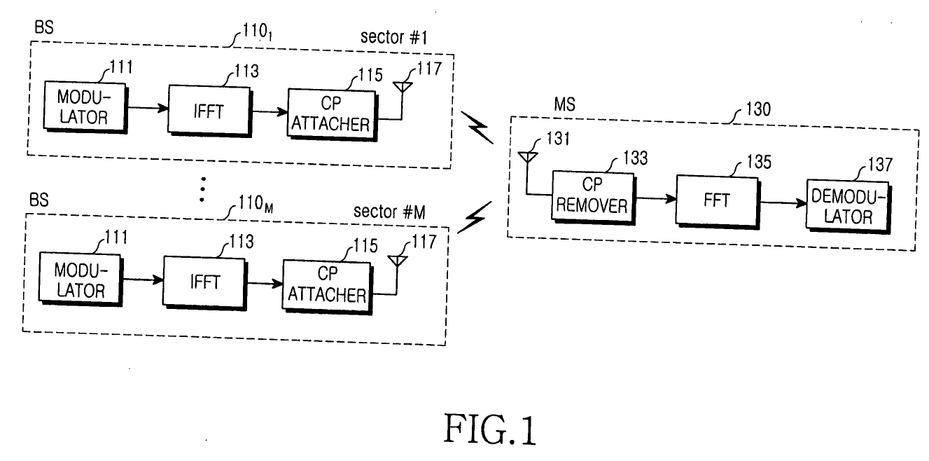

Throughout the drawings, the same or similar elements are denoted by the same reference numerals.

### DETAILED DESCRIPTION OF EXEMPLARY EMBODIMENTS

Several embodiments of the present invention will now be described in detail with reference to the accompanying drawings. In the following description, a detailed description of known functions and configurations incorporated herein has been omitted for conciseness.

Before a description of embodiments of the present invention is given, a basic concept of the present invention will be described in brief.

The foregoing assumption that the same data is transmitted in each sector in a wireless mobile communication system employing the orthogonal frequency division multiplexing (OFDM) transmission scheme can be fully achieved because base stations can transmit the same data under the control of a base station controller. However, when the same data like the broadcast data is broadcasted in each sector, signals transmitted from each base station to a mobile station are not subject to power control. Therefore, even though there is no interference component, reception power of the signals can be attenuated in a cell/sector boundary, causing performance degradation.

Therefore, the present invention provides a scheme for enabling a mobile station to obtain a sector diversity gain by applying space-time coding (STC), which is one of the transmit diversity techniques, to the signals transmitted in each sector in order to improve reception performance of the mobile station in a cell/sector boundary.

The scheme proposed in the present invention will be described with reference to the following three preferred embodiments.

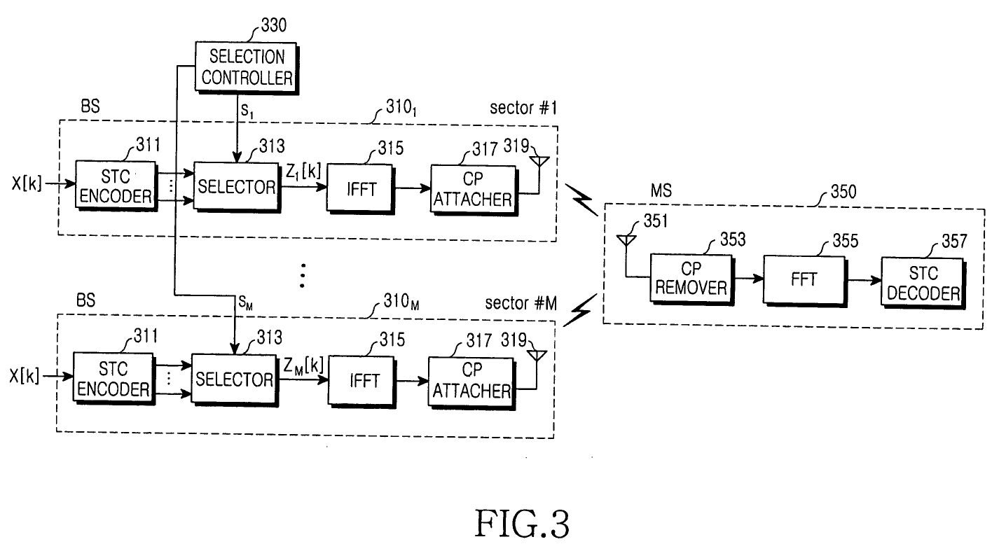

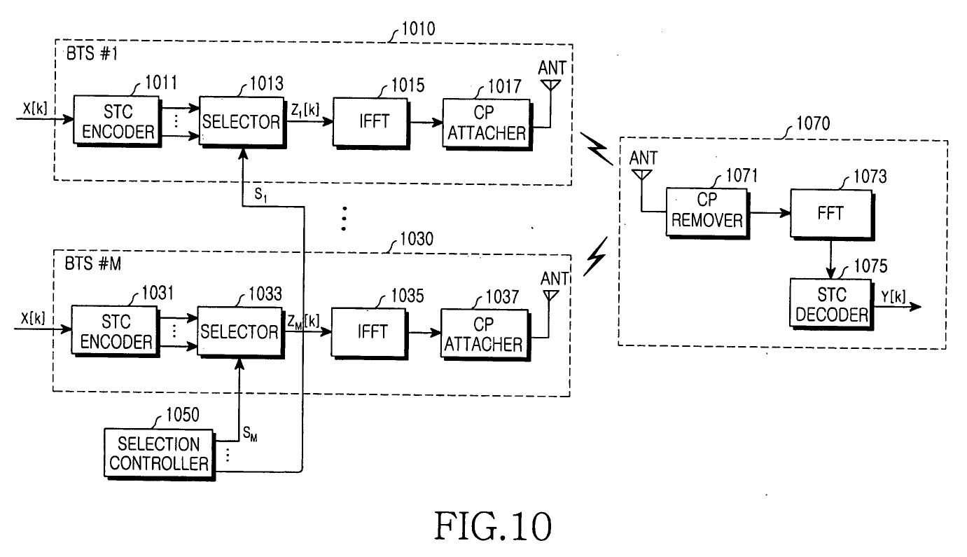

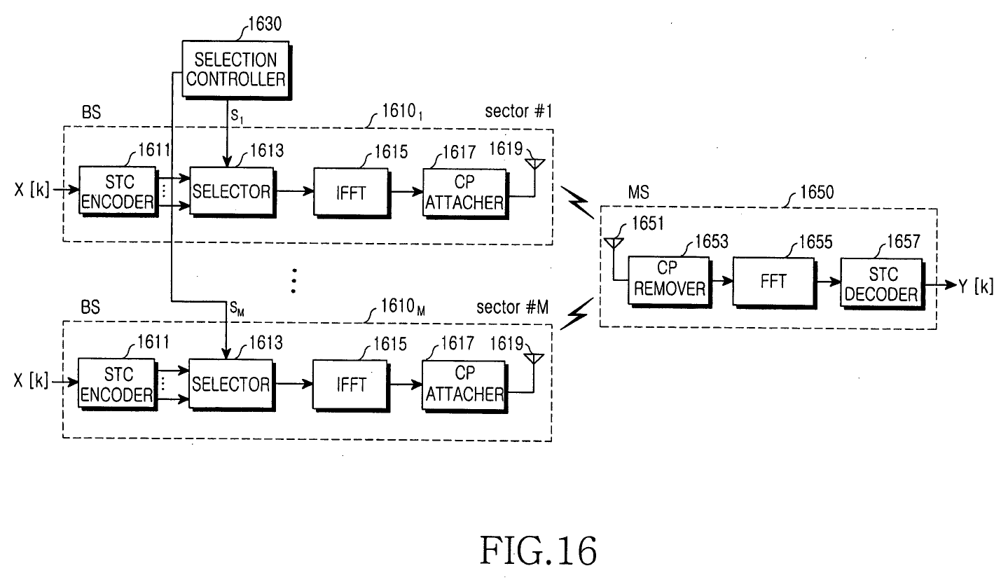

A first embodiment of the present invention described with reference to FIGS. 3 to 9 proposes a sector structure in which a sector/cell diversity gain can be maximized when an Alamouti space-time coding scheme is used as the space-time coding scheme, and also proposes a per-sector space-time code stream arrangement method appropriate for the sector structure. A second embodiment of the present invention described with reference to FIGS. 10 to 15 proposes a sector structure in which a sector/cell diversity gain can be maximized when a Tarokh time-space coding scheme is used as the space-time coding scheme, and also proposes a per-sector space-time code stream arrangement method appropriate for the sector structure. Finally, a third embodiment of the present invention described with reference to FIGS. 16 to 28 proposes a method for selecting space-time code streams output from each base station such that an arrangement pattern for space-time code streams output from an STC encoder circulates at predetermined periods.

A description of the present invention will be separately made with reference to one embodiment in which the space-time coding is applied to the OFDM transmission scheme in a space and frequency domain, and another embodiment in which the space-time coding is applied to the OFDM transmission scheme in a space and time domain.

According to a novel method of periodically selecting one of two space-time code streams for every sector belonging to a base station prior to transmission, a sector diversity gain is not concentrated on a mobile station located in a specific position but distributed to all mobile stations located in a cell/sector boundary.

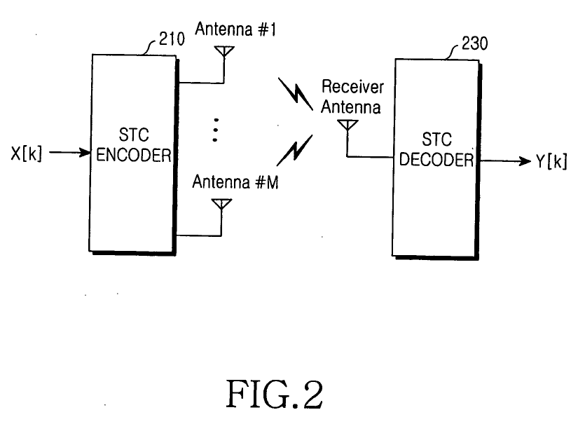

For a better understanding of the present invention, the space-time coding technique will be described in brief below with reference to FIG. 2.

Referring to FIG. 2, in the space-time coding technique, an STC encoder 210 STC-encodes a series of input data symbols X[k] into a plurality of parallel data symbol streams and transmits the parallel data symbol streams to a mobile station using a plurality of transmission antennas Antenna#1 to Antenna#M. The mobile station receives data transmitted from the transmission antennas Antenna#1 to Antenna#M via its antenna, and an STC decoder 230 in the mobile station STC-decodes the received data into its original data Y[k]. A transmit diversity gain is acquired through such a transmission process.

If the same symbol streams are parallel transmitted via multiple transmission antennas Antenna#1 to Antenna#M through different space-time coding schemes, a mobile station receives the symbols parallel transmitted from the multiple transmission antennas. In this case, the purpose of encoding symbols in the STC encoder 210 is not to allow the mobile station to acquire a coding gain, but to allow the mobile station to acquire a diversity gain by distinguishing the antennas via which the symbols were transmitted. Thus, if the mobile station receives the symbols transmitted from the transmission antennas and decodes the received symbols, all of the decoded symbols are equal to each other. Therefore, the STC decoder 230 STC-decodes the symbols transmitted from the transmission antennas. Because all of the decoded symbols are equal to each other, the mobile station can restore the symbols to their original symbols by combining them. Therefore, the mobile station decodes different space-time code streams transmitted by a base station using diversity combining, thereby obtaining a diversity gain.

Although it is shown in FIG. 2 that a plurality of transmission antennas are connected to the output terminals of the STC encoder 210 for a description of the space-time coding technique, the STC encoder 210 can be provided to each sector formed by a base station and at least one sector is formed in each cell formed by the base station. Therefore, the antennas Antenna#1 to Antenna#M of FIG. 2 are given for conceptual illustration of the antennas for outputting space-time code streams to multiple sectors.

The space-time coding technique comprises a space-time block coding scheme implemented using a simple encoder/decoder structure, and an Alamouti space-time block coding scheme is commonly used as a space-time coding scheme with a coding rate of 1. In the space-time block coding scheme, a maximum likelihood (ML) reception structure can be simply implemented in a receiver through a linear process using orthogonal codes. Particularly, the Alamouti space-time coding scheme encodes two input symbol streams and transmits the coded symbol streams using two transmission antennas. Herein, a space-time code stream coded by the Alamouti space-time coding scheme corresponds to an orthogonal code that uses complex symbols as an input and satisfies a coding rate of 1 and full diversity.

The present invention proposes a scheme for providing sector diversity using Tarokh space-time coding as the time-space coding scheme. In the Tarokh space-time coding scheme with a coding rate of ¾, an STC encoder receives 3 symbols in parallel and outputs 4 space-time code streams using the received symbols. A detailed description will be made below regarding how to apply the Alamouti space-time coding scheme and the Tarokh space-time coding scheme to the present invention.

The novel method described below can be used for transmission of downlink data for a broadcast service based on the OFDM transmission scheme in a CDMA2000 first evolution data and voice (1× EV-DO) standard which is a 3^{rd} generation (3G) synchronous network standard. In the near future, if a wideband code division multiple access (WCDMA) cellular system provides a broadcast service using the OFDM transmission scheme, the novel method can be applied thereto in the same manner. That is, it should be noted that the present invention can be used together with the OFDM transmission technique if base stations can transmit the same data as a cellular system comprises such a unit as the base station controller.

The first embodiment of the present invention will now be described in detail with reference to FIGS. 3 to 9.

FIG. 3 is a block diagram illustrating a structure of a wireless mobile communication system to which an OFDM symbol transmission method according to a first embodiment of the present invention is applied. It is assumed in FIG. 3 that the wireless mobile communication system has a multicell/multisector structure and is designed to transmit signals using the OFDM transmission scheme. It is also assumed in the system of FIG. 3 that the same data can be transmitted from the different cells or sectors such as in a broadcast system. This assumption is based on the fact that in a cellular system, even the sectors belonging to different base stations (BSs) 310₁ to 310_{M} can transmit the same data to a mobile station (MS) 600 under the control of a base station controller (not shown).

However, when the same data is transmitted through the different base stations 310, a sufficient diversity gain cannot be acquired from different sectors in a sector boundary as described with reference to FIG. 2. Therefore, a STC encoder 311 of FIG. 3 STC-encodes input complex symbols according to the Alamouti space-time coding scheme before performing inverse fast Fourier transform (IFFT) on transmission data and transmitting the IFFT-processed data to each of the sectors.

The complex symbols input to the STC encoder 311 are arranged per adjacent subcarriers in the case where the space-time coding is performed in a space and frequency domain, and arranged per OFDM symbol interval in the case where the space-time coding is performed in a space and time domain. When the complex symbols are input in the space and time domain, it is preferable to arrange an arrangement buffer for arrangement of the complex symbols in a front stage of the STC encoder 311.

A selector 313 selects one of a plurality of space-time code streams acquired through the space-time coding, and transmits the selected space-time code stream to a corresponding sector. Herein, the selector 313 selects one of the outputs of the STC encoder 311 under the control of a selection controller 330 and outputs the selected signal to an inverse fast Fourier transform block (IFFT) 315.

However, when the space-time coding is performed in the space and time domain, it is preferable to arrange, in the selector 313 or between the selector 313 and the IFFT 315, a rearrangement buffer (not shown) for rearranging the space-time code streams such that the selected space-time code stream is transmitted through adjacent OFDM symbols.

The IFFT 315 performs IFFT on data to be transmitted to the mobile station 350 to convert the transmission data into time-domain data, and outputs the IFFT-processed data to a CP attacher 317. The CP attacher 317 attaches a cyclic prefix symbol (CP) to the IFFT-processed OFDM data and outputs an OFDM symbol. The OFDM symbol is transmitted to a corresponding one of the sectors Sector#1 to Sector#M via an antenna 319.

In the structure of FIG. 3, if a transmitter of the base station performs a modulation process using IFFT, a receiver of the mobile station performs a demodulation process using fast Fourier transform (FFT). Alternatively, the transmitter of the base station can perform the modulation process using FFT, and in this case, the receiver of the mobile station performs the demodulation process using IFFT. For convenience, it will be assumed herein that the IFFT and the FFT are used for modulation and demodulation, respectively, as shown in FIG. 3.

In the base station 310, the STC encoder 311, the selector 313, the IFFT 315 and the selection controller 330 comprise an OFDM symbol transmission device according to an embodiment of the present invention. Preferably, the selection controller 330 is included in a base station controller (not shown) so that it controls the selector 313 included in each base station 310. The selection controller 330 can be either combined with the selector 313 or separately included in each base station 310 in the case where output of the space-time code streams is fixed or switched every predetermined time.

Herein, the STC encoder 311 preferably uses the Alamouti space-time coding scheme, and is designed to receive two complex symbols and output two different coded symbol streams, i.e., space-time code streams, and its coding matrix C is defined as a 2×2 matrix shown in Equation (3) below.

$$C = [ \begin{matrix}{X}_{1} & {X}_{2} \\ - {X}_{2}^{*} & {X}_{1}^{*}\end{matrix} ] \qquad ( 3 )$$

where X₁ and X₂ denote complex symbols input to the STC encoder 311.

The STC encoder 311 outputs two different space-time code streams in accordance with Equation (3).

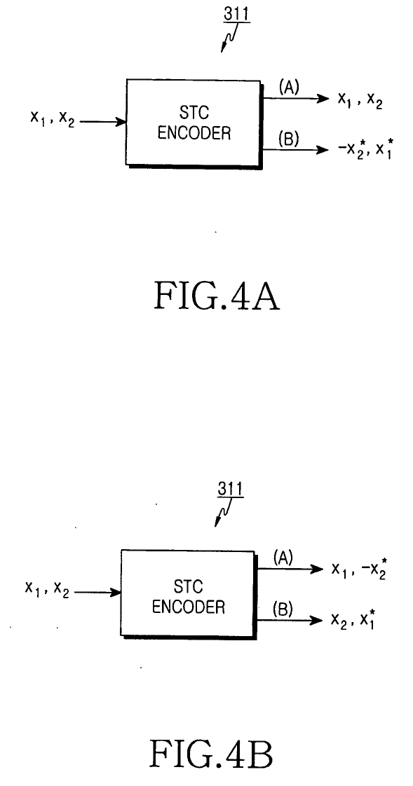

FIGS. 4A and 4B are diagrams illustrating different examples of space-time code streams output from the STC encoder 311 of FIG. 3. Specifically, FIG. 4A illustrates a space-time code stream (A) of {X₁, X₂} and a space-time code stream (B) of {−X₂*, X₁*}, which are output on the basis of row vectors of the coding matrix C, and FIG. 4B illustrates a space-time code stream (A) of {X₁, −X₂*} and a space-time code stream (B) of {X₂, X₁*}, which are output on the basis of column vectors of the coding matrix C. Every sector can use either the STC encoder 311 of FIG. 4A or the STC encoder 311 of FIG. 4B. One of the space-time code streams (A) and (B) is selected by the selector 313 under the control of the selection controller 330 that determines which space-time code stream it will select and transmit in each sector.

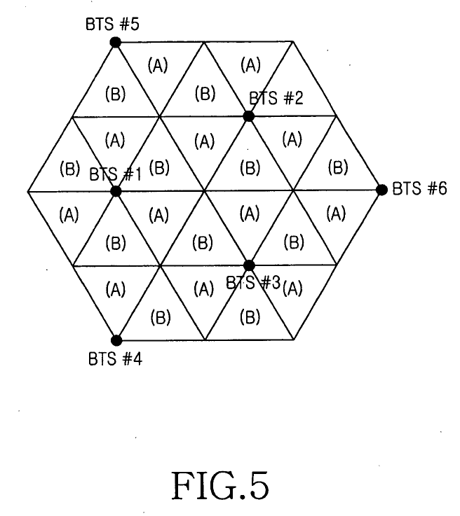

When the mobile station 350 is located in a sector boundary, different space-time code streams from different sectors are transmitted to the mobile station 350. In this case, in order to maximize a sector diversity gain and increase the overall cell capacity, the present invention provides a cell with a 6-sector structure shown in FIG. 5. Although a cell with a 6-sector structure is proposed herein, a cell sectorized into as many sectors as a multiple of 6, for example, 12, 18, 24, . . . , is also available.

FIG. 5 is a diagram illustrating an example of a sector structure to which an embodiment of the present invention is applied. In FIG. 5, BTS#1 to BTS#6 represents the base stations 310, and (A) and (B) represent the space-time code streams described with reference to FIGS. 4A and 4B. Therefore, if the selection controller 330 transmits control signals S₁, S₂, . . . , S_{M} to the selectors 313 of the base stations 310, each of the selectors 313 selects one of the space-time code streams (A) and (B) according to the corresponding control signal. Each sector allows the selector 313 to select the space-time code streams to be transmitted therein as illustrated in FIG. 5, and in this case, the maximum sector diversity gain can be obtained.

It should be noted that the receiver of the mobile station 350 can restore data using one STC decoder regardless of a change in the space-time code stream. That is, in FIG. 3, the mobile station 350 receives OFDM symbols transmitted from a sector boundary, via an antenna 351. In the mobile station 350, a CP remover 353 detaches a CP from the received OFDM symbol, and delivers the CP-detached OFDM symbol to a fast Fourier transform block (FFT) 355. The FFT 355 performs fast Fourier transform on the OFDM symbol to convert the OFDM symbol into a frequency-domain signal, and outputs the FFT-processed OFDM symbol to an STC decoder 357. The STC decoder 357 decodes the FFT-processed OFDM symbol into the original space-time code stream using the Alamouti space-time coding scheme.

Given that the Alamouti space-time code has a coding rate of 1, the STC decoder 357 can decode data without a loss of a data rate in a region adjacent to the base station 310, not in a sector boundary. In the sector boundary, the STC decoder 357 obtains a sector diversity gain by receiving STC-encoded signals from the base stations 310 in the different sectors. Therefore, the mobile station 350 does not require a position information decoding process, making it possible to efficiently increase the overall cell capacity without a separate device.

According to a space-time coding theory, in the process of transmitting the space-time code streams, channel variation during transmission of two STC-encoded symbols should be negligible. This is because as the channel variation becomes more significant, performance of STC-decoded signals is deteriorated, causing a loss of orthogonality between the multiple space-time code streams and a reduction in data rate.

In order to satisfy the hypothesis, the present invention provides one scheme of transmitting space-time code streams using two adjacent subcarriers in an OFDM symbol and another scheme of transmitting space-time code streams using one subcarrier for a period of two adjacent OFDM symbols, based on the fact that the OFDM transmission scheme can use both a time domain and a frequency domain.

Herein, the former scheme of transmitting space-time code streams with two adjacent subcarriers will be referred to as a “Space-Frequency Coded OFDM (SFC-OFDM) scheme,” and the latter scheme of transmitting space-time code streams for a period of two adjacent OFDM symbols will be referred to as a “Space-Time Coded OFDM (STC-OFDM) scheme.”

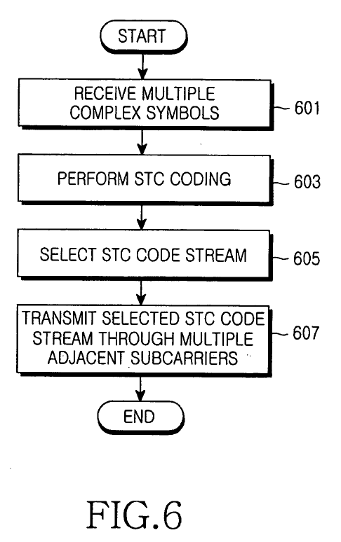

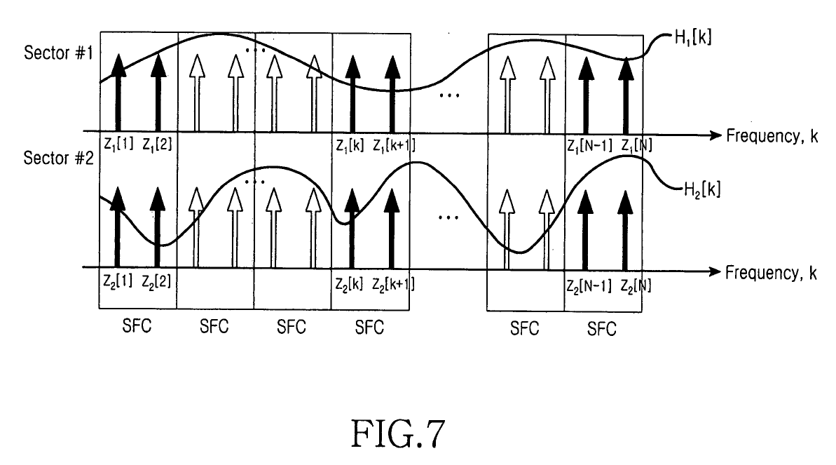

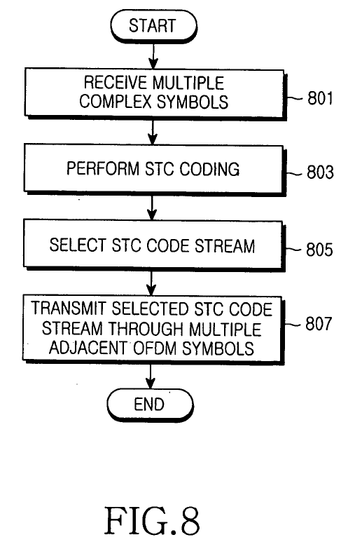

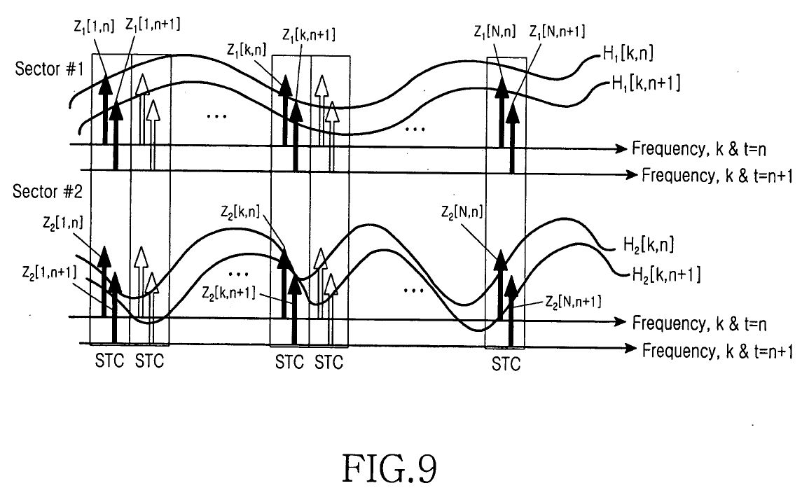

Now, an OFDM symbol transmission method based on the SFC-OFDM scheme will be described with reference to FIGS. 6 and 7, and thereafter, an OFDM symbol transmission method based on the STC-OFDM scheme will be described with reference to FIGS. 8 and 9.

For reference, in FIGS. 7 and 9, block arrows represent subcarriers with which space-time code streams for broadcast data are modulated, and white arrows represent subcarriers with which space-time code streams for unicast data are modulated. Sector#1 and Sector#2 each selectively transmit one of the space-time code streams (A) and (B) of FIG. 5. H₁[k] and H₂[k] represent channel components of signals transmitted from a 1^{st} base station and a 2^{nd} base station through a k^{th} subcarrier, respectively.

FIG. 6 is a flowchart of an OFDM symbol transmission method based on an SFC-OFDM scheme according to the first embodiment of the present invention, and FIG. 7 is a diagram illustrating a process of transmitting space-time code streams in the method of FIG. 6.

Referring to FIG. 6, in step 601, each base station defines broadcast data or unicast symbols to be modulated with N subcarriers as X[k], where k=1, 2, . . . , N, and inputs two complex symbols X(k) and X(k+1) to an STC encoder 311. In step 603, the STC encoder 311 receiving the two complex symbols X(k) and X(k+1), STC-encodes the two complex symbols X(k) and X(k+1) according to the Alamouti space-time coding scheme such that the space-time code streams of FIG. 4A or FIG. 4B are output through the coding matrix C of Equation (3).

In step 605, a selection controller 330 outputs control signals S₁ to S_{M} to their associated selectors 313 such that the sector structure of FIG. 5 should be formed, and each of the selectors 313 receiving their control signals S₁ to S_{M} selects one of two space-time code streams output from the STC encoder 311 of FIG. 4A or 4B. In addition, the selection controller 330 transmits another control signal to each selector 313 such that the selected space-time code stream is transmitted through two adjacent subcarriers.

Thereafter, in step 607, the selected space-time code stream is converted into an OFDM symbol through an IFFT 315 and a CP attacher 317, and then transmitted to a corresponding sector. The selector 313 controls an operation of the IFFT 315 such that each pair, {Z₁[k], Z₁[k+1]}, . . . , {Z_{M}[k], Z_{M}[k+1]}, of space-time code streams should be transmitted through two adjacent subcarriers as shown in FIG. 7.

More specifically, FIG. 7 illustrates a process in which a space-time code stream is applied to every two adjacent subcarriers in the same OFDM symbol prior to being transmitted, wherein the same space-time encoders are used in different sectors but different space-time code streams are transmitted. If each base station defines symbols for broadcast or unicast to be transmitted on N subcarriers as X[k], where k=1, 2, . . . , N, the base station receives two complex symbols X(k) and X(k+1). For example, in the case where the STC encoder 311 of FIG. 4A is used, the base station finds {Z₁[k], Z₁[k+1]}={X[k], X[k+1} and {Z₂[k], Z₂[k+1]}={−X*[k+1], X*[k]} by STC-encoding the input complex symbols through the coding matrix C of Equation (3), and transmits a selected one of the symbol pairs.

FIG. 8 is a flowchart of an OFDM symbol transmission method based on an STC-OFDM scheme according to the first embodiment of the present invention, and FIG. 9 is a diagram illustrating a process of transmitting space-time code streams in the method of FIG. 8.

Referring to FIG. 8, because steps 801 and 803 of STC-encoding multiple complex input symbols according to the Alamouti space-time coding scheme are equal to the steps 601 and 603 of FIG. 6, a detailed description thereof will be omitted. In step 805, a selection controller 330 outputs control signals S₁ to S_{M} to their associated selectors 313 such that the sector structure of FIG. 5 should be formed, and each of the selectors 313 receiving their control signals S₁ to S_{M} selects one of two space-time code streams output from the STC encoder 311 of FIG. 4A or 4B. In addition, the selection controller 330 transmits another control signal to each selector 313 such that the selected space-time code stream is transmitted through two adjacent OFDM symbols.

Thereafter, in step 807, the selected space-time code stream is converted into an OFDM symbol through an IFFT 315 and a CP attacher 317, and then transmitted to a corresponding sector. The selector 313 controls an operation of the IFFT 315 such that each pair, {Z₁[k], Z₁[k+1]}, . . . , {Z_{M}[k], Z_{M}[k+1]}, of space-time code streams should be transmitted through two adjacent OFDM symbols as shown in FIG. 9.

More specifically, FIG. 9 illustrates a process in which the same space-time encoders are used in different sectors for a period of two adjacent OFDM symbols but different space-time code streams are transmitted using one subcarrier. If each base station defines symbols for broadcast or unicast to be transmitted on N subcarriers for an n^{th} OFDM symbol and an (n+1)th OFDM symbol as X[k, n] and X[k, n+1], where k=1, 2, . . . , N, the base station receives two complex symbols X[k, n] and X[k, n+1]. For example, in the case where the STC encoder 311 of FIG. 4A is used, the base station finds {Z₁[k, n], Z₁[k, n+1]}={X[k, n], X[k, n+1]} and {Z₂[k, n], Z₂[k, n+1]}={−X*[k, n+1], X*[k, n]} by STC-encoding the input complex symbols through the coding matrix C of Equation (3), and transmits a selected one of the symbol pairs. Herein, ‘n’ denotes an index for distinguishing a time slot.

Summarizing the novel OFDM symbol transmission scheme, the SFC-OFDM scheme described with reference to FIGS. 6 and 7 performs space-time coding on two adjacent subcarriers, and preferably, the SFC-OFDM scheme is used when there is almost no channel variation between two adjacent subcarriers. The STC-OFDM scheme described with reference to FIGS. 8 and 9 performs space-time coding on two adjacent OFDM symbols, and preferably, the STC-OFDM scheme is used when there is almost no channel variation between two adjacent OFDM symbols.

Finally, it should be noted that because the space-time coding scheme to which the present invention is applied has a coding rate of 1, even though data is received from any one of the sectors, the received data can be demodulated without a change in reception performance. Therefore, a base station can perform space-time coding on all subcarriers before transmission regardless of transmission of broadcast data or unicast data. A mobile station can receive data in any position within a cell without cell discrimination by applying an STC encoder to all subcarriers, and can obtain an enhanced sector diversity gain compared with the conventional technology, especially in a sector boundary.

The second embodiment of the present invention will now be described in detail with reference to FIGS. 10 to 15.

FIG. 10 is a block diagram of a broadcast data transceiver for a mobile communication system to which an embodiment of the present invention is applied. With reference to FIG. 10, a detailed description will be made of a structure and operation of a broadcast data transceiver for a mobile communication system to which an embodiment of the present invention is applied, and the overall operation of the system.

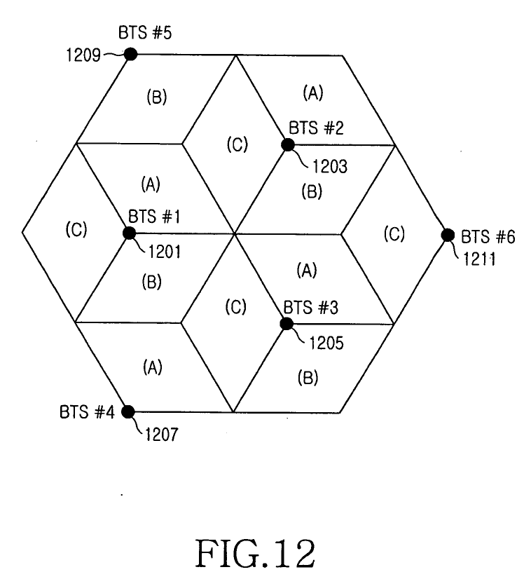

Referring to FIG. 10, base stations (or base station transceiver subsystems (BTSs)) 1010 through 1030 can be either different base stations, or different cells or sectors in one base station. The overall configuration of the base stations (or cells/sectors) will be described later in more detail with reference to FIG. 12. For convenience, it will be assumed herein that the base stations 1010 through 1030 are different base stations. A mobile station (MS) 1070 can receive a signal of the mobile communication system, and is assumed as a mobile station capable of receiving an OFDM signal according to an embodiment of the present invention. FIG. 10 illustrates only the elements needed for a description of the present invention, and even the non-illustrated elements will be described in brief if needed. The embodiments of the present invention will be described based on the assumption that the base stations transmit data for the same broadcast service using the same subcarriers.

The base stations 1010 through 1030 all transmit the same broadcast data. Generally, because a synchronous CDMA mobile communication system transmits data from a base station controller (BSC; not shown) to base stations (or BTSs), it can provide the same broadcast service to each base station. In addition, since a mobile communication system capable of providing a broadcast service receives broadcast data via a packet data service node (PDSN; not shown), it can enable the PDSN to transmit the same broadcast service data to the base stations. Alternatively, the mobile communication system can transmit the same broadcast service to the base stations via a packet control function (PCF; not shown), located in the same or higher layer of the base station controller. Because it is preferable that the base station controller from among the foregoing elements (base station controller, PDSN and PCF) transmits the same broadcast data, it will be assumed herein that the same broadcast data stream is received from the base station controller. Therefore, each of the base stations 1010 through 1030 performs a procedure for transmitting the same broadcast data stream. It is assumed in FIG. 10 that the broadcast service data processed by the base stations 1010 through 1030 is the same broadcast data. In addition, because the base stations 1010 through 1030 are equal to each other in terms of a process of processing a broadcast service symbol stream X[k], an internal structure and operation of only the first base station (BTS#1) 1010 will be described for the sake of clarity and conciseness.

The broadcast service symbol stream X[k] can be either one of (A) symbols subjected to channel coding and modulation, to be transmitted over a radio channel, (B) symbols subjected to either channel coding or modulation, and (C) raw broadcast data. For convenience, it will be assumed herein that the broadcast service symbol stream X[k] is the symbols subjected to channel coding and modulation. The broadcast service symbol stream X[k] is input to a space-time coding (STC) encoder 1011 of the first base station 1010. The STC encoder 1011 encodes the input broadcast service symbol stream.

The STC encoder 1011 STC-codes the broadcast symbol streams such that the input symbol streams can be transmitted via the plurality of antennas, and outputs the STC-coded symbols to a selector 1013. The selector 1013 selects a transmission symbol stream from among the received symbols based on a selection signal input from a selection controller 1050. In FIG. 10, the transmission symbol stream selected by the selector 1013 of the first base station 1010 is denoted by Z₁[k] and a transmission symbol stream selected by the selector 1033 of the M^{th} base station 1030 is denoted by Z_{M}[k]. In this way, the selector 1013 determines a symbol stream that the first base station 1010 will transmit. After selecting the transmission symbols, the selector 1013 outputs the transmission symbols to an inverse fast Fourier transform block (IFFT) 1015. The IFFT 1015 converts the input OFDM symbols into a time-domain signal, and outputs the time-domain signal to a cyclic prefix (CP) attacher 1017.

The CP attacher 1017 copies a predetermined number of last symbols from among the transmission OFDM symbols and adds the copied symbols to the header of the transmission symbols, and outputs the final transmission symbols to a transmitter (not shown). The transmitter converts the transmission symbols into a radio frequency (RF) signal in a frequency band preset in the mobile communication system, and transmits the RF signal over an air channel. The operation of the CP attacher 1017 should be performed such that a delay spread of the transmission signal received at a mobile station is less than a length of the CP, in order to prevent an interference component between OFDM symbols. If the delay spread of the received signal is greater than the CP, a difference in the length between the delay spread and the CP should be insignificant such that an interference component between adjacent symbols is ignorable.

The M^{th} base station 1030 is equal in operation to the first base station 1010. Therefore, the M^{th} base station 1030 transmits the same broadcast data using the same method.

Next, the selection controller 1050 of FIG. 10 will be described. The selection controller 1050 can be included in a base station controller (BSC), a packet control function (PCF) located in an upper layer of the BSC, or a packet data service node (PDSN). It is preferable that the selection controller 1050 be included in the base station controller. Therefore, in the following description, it will be assumed that the selection controller 1050 is included in the base station controller. The selection controller 1050 is provided to allow STC encoders in the base stations to select different transmission symbols from among a plurality of symbols generated therein. This is to enable a mobile station receiving a broadcast service in the vicinity of base station boundary to distinguish the coded symbols for the broadcast service received from different base stations. In this way, the mobile station receiving the broadcast service in the vicinity of the base station boundary can receive the same broadcast service symbol streams coded for different sectors, thereby acquiring diversity. In the following description, the diversity acquired in this manner will be referred to as “sector diversity.” A method for arranging coded symbol streams transmitted from the different sectors to acquire the sector diversity will be described later in more detailed with reference to FIG. 12.

Among the elements included in the base station of FIG. 10, the STC encoders (1011, . . . , 221) and the selectors (1013, . . . , 1033) can preferably be included in the base station controller. In this case, the STC encoders can be implemented with one STC encoder, and the symbols coded by the STC encoder are input to selectors (1013, . . . , 1033), which are included in the base station controller. The selectors (1013, . . . , 1033) select transmission symbols mapped to their associated base stations. Then each of the selectors (1013, . . . , 1033) mapped to their associated base stations selects a transmission signal based on a control signal from the selection controller 1050 and transmits the selected transmission signal to its base station. When the STC encoders (1011, . . . , 221) and the selectors (1013, . . . , 1033) are included in the base station controller in this way, the data transmitted to each base station is STC-coded data. In this case, the amount of data to be transmitted between the base station and the base station controller can be greater than or equal to that in the case where the space-time coding is not performed. Therefore, the selector can be included in the base station controller or the base station considering the cost of a link occupied between the base station controller and the base station and the cost of related devices.

Only the STC encoders and the selection controller 1050 can be installed in the base station controller. In this case, each base station can include its own selector and the base station controller transmits the overall symbol streams coded in the STC encoder to each base station. Therefore, this method increases the amount of data to be transmitted between the base station and the base station controller, decreasing data transmission efficiency.

Another method can determine STC-coded symbol streams to be transmitted by cells/sectors of each base station in a predetermined manner when installing the base stations. In this case, the selection controller 1050 is unnecessary, and this method can be implemented by designing the selector such that it outputs only predetermined symbols.

Further another method can include only the selection controller 1050 in the base station controller. In this case, each base station can include its own STC encoder and selector, and a selector in each base station selects one of a plurality of output symbol streams of an STC encoder in the base station according to a control signal transmitted from the base station controller.

Next, a structure and operation of the mobile station 1070 according to an embodiment of the present invention will be described in more detail. The mobile station 1070 of FIG. 10 receives broadcast symbols transmitted with the OFDM scheme via an antenna ANT. A CP remover 1071 removes a CP added to the received broadcast symbols during transmission, and outputs the CP-removed broadcast symbols to a fast Fourier transform block (FFT) 1073. The FFT 1073 converts the time-domain broadcast symbols into OFDM symbols, and outputs the OFDM symbols or symbol streams to an STC decoder 1075. When receiving a broadcast data symbol stream from only one base station, the STC decoder 1075 simply decodes the received broadcast symbol stream. However, when receiving broadcast data symbol streams from two or more base stations, the STC decoder 1075, as it can distinguish symbol streams received from different base stations, separately decodes the received broadcast data symbol streams, thereby acquiring sector diversity.

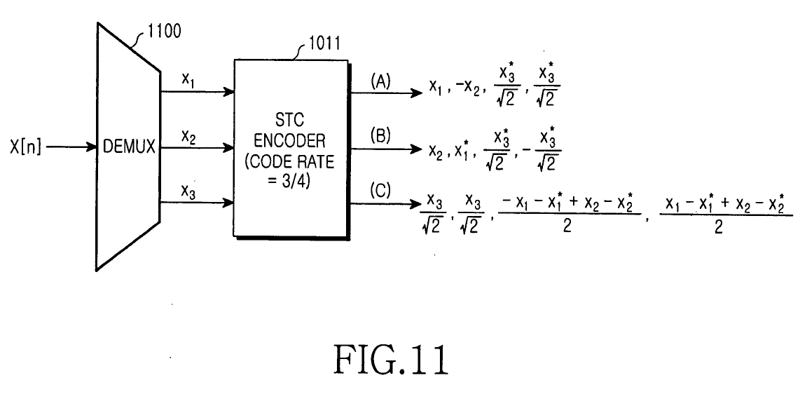

The STC encoders of FIG. 10 will be described in more detail with reference to FIG. 11. FIG. 11 is a peripheral circuit diagram for the description of an operation of the STC encoder illustrated in FIG. 10.

Referring to FIG. 11, broadcast service symbol streams X[n] are input to a demultiplexer (DEMUX) 1100. The demultiplexer 1100 demultiplexes the input broadcast service symbol streams and outputs the results to an STC encoder 1011. In an embodiment of the present invention, it is assumed that the STC encoder 1011 has a coding rate of ¾. Therefore, the demultiplexer 1100 demultiplexes the input broadcast service symbol streams X[n] per 3 symbols. Upon receiving the symbols in parallel on a three-by-three basis, the STC encoder 1011 outputs 4 coded symbols for each of the received symbols. Herein, the STC encoder 1011 uses a coding scheme proposed by Tarokh (hereinafter referred to as a Tarokh coding scheme).

The STC encoder 1011 using the Tarokh coding scheme (also known as a Tarokh encoder) STC-codes the 3 input symbols, and outputs 3 kinds of coded symbols. The output symbol streams C₃ coded by the Tarokh encoder can be expressed as

$${C}_{3} = [ \begin{matrix}{x}_{1} & {x}_{2} & \frac{{x}_{3}}{\sqrt{2}} \\ - {x}_{2}^{*} & {x}_{1}^{*} & \frac{{x}_{3}}{\sqrt{2}} \\ \frac{{x}_{3}^{*}}{\sqrt{2}} & \frac{{x}_{3}^{*}}{\sqrt{2}} & \frac{- {x}_{1} - {x}_{1}^{*} + {x}_{2} - {x}_{2}^{*}}{2} \\ \frac{{x}_{3}^{*}}{\sqrt{2}} & - \frac{{x}_{3}^{*}}{\sqrt{2}} & \frac{{x}_{1} - {x}_{1}^{*} + {x}_{2} - {x}_{2}^{*}}{2}\end{matrix} ] \qquad Equation ( 4 )$$

Equation (4) shows an example of the symbol streams output from the STC encoder 1011. In Equation (4), a first column corresponds to coded symbols (A) of FIG. 11, a second column corresponds to coded symbols (B) of FIG. 11, and a third column corresponds to coded symbols (C) of FIG. 11. The 3 symbol streams STC-coded in this way are input to a corresponding one of the selectors (1013, . . . , 1033) illustrated in FIG. 10. The selector (1013, . . . , 1033) selects coded symbols for a column stream to be transmitted in its associated base station (or cell/sector). The selector (1013, . . . , 1033) performs the selection according to a corresponding one of selection control signals S₁ through S_{M} output from the selection controller 1050. That is, the selection controller 1050 generates a selection control signal for allowing one of the symbol streams output from the FIG. 11 to be transmitted in a specific sector, and outputs the selection control signal to a corresponding selector.

The reason why the STC encoder 1011 is designed to use the coding rate of ¾ as illustrated in FIG. 11 is because the general mobile communication system has a 3-sector structure. That is, this is to allow different sectors to transmit different coded symbols so that a mobile station receiving broadcast service symbols in a sector/cell boundary of a base station distinguishes the sectors/cells from which the received symbols were transmitted, thereby obtaining a full sector diversity gain.

FIG. 12 is a diagram illustrating a cell configuration for acquiring sector diversity of broadcast service data in a mobile communication system with a 3-sector structure according to the second embodiment of the present invention. With reference to FIG. 12, a description will now be made of a cell configuration for acquiring sector diversity of broadcast service data in a mobile communication system with a 3-sector structure according to an embodiment of the present invention, and an effect thereof.

Referring to FIG. 12, the mobile communication system includes base stations 1201, 1203, 1205, 1207, 1209 and 1211, each of which has a 3-sector structure. It is assumed that all of the base stations 1201 through 1211 provide the same broadcast service. In this case, the base stations 1201 through 1211 are controlled such that the output symbol streams of the STC encoder 1011 associated with each sector, described with reference to FIG. 11, should not overlap each other. That is, in FIG. 12, (A) represents the top one of the outputs of the STC encoder 1011 of FIG. 11, and also represents coded symbols in a first column of Equation (4). In addition, (B) represents the middle one of the outputs of the STC encoder 1011 of FIG. 11, and also represents coded symbols in a second column of Equation (4). Finally, (C) represents the bottom one of the outputs of the STC encoder 1011 of FIG. 11, and also represents coded symbols in a third column of Equation (4). As can be understood from FIG. 12, when each base station has a 3-sector structure, each sector of the base station transmits a different output symbol stream of its associated STC encoder. In addition, a sector of a specific base station is also different from a sector of an adjacent base station in terms of the output symbol streams of their associated STC encoders. In the cell configuration of FIG. 12, a mobile station located in the vicinity of a specific sector boundary of a base station receives different output symbol streams of at least two different STC encoders. Because the mobile station can distinguish broadcast service symbols received from each sector, it can acquire sector diversity. The embodiments of the present invention can be applied in the same way even when the number of sectors of each base station is a multiple of 3 or another number of sectors/cells or base stations.

Alternatively, the base stations of FIG. 12 can be designed such that each of them transmits output symbol streams of its STC encoder on a circular basis rather than on a fixed basis. An example thereof will be described below. In a first base station BTS#1 (1201), a sector currently outputting a symbol stream (A) outputs a symbol stream (B) after a lapse of a predetermined time, and outputs a symbol stream (C) after another lapse of the predetermined time. After a further lapse of the predetermined time, the sector outputs the symbol stream (A), thereby achieving circular transmission. When a specific sector performs circular transmission on a broadcast service in this manner, all of its adjacent sectors should also change output symbol streams thereof on a circular basis so that the same symbol streams are not transmitted from the adjacent sectors. In this manner, the mobile communication system enables a mobile station located in a sector boundary to acquire sector diversity. Even though the broadcast service undergoes circular transmission as described above, the mobile station does not require an additional structure, and can achieve data restoration irrespective of the change in the coded symbol streams.

In this alternative method, the selection controller 1050 of FIG. 10 should control the selectors such that they select broadcast service symbols all of which are transmitted in sync with each other. Actually, in the mobile communication system, symbols output from all base stations should be synchronized with each other in order to acquire sector diversity. Therefore, this method can be more efficiently used in the synchronous mobile communication system. However, the same effect can be obtained even in the asynchronous WCDMA mobile communication system if the broadcast service is transmitted on a synchronous basis. The mobile communication system can increase the overall cell capacity by enabling the adjacent sectors to transmit different STC-coded symbol streams as shown in FIG. 12.

In order to transmit the STC-coded symbols as described above, each sector of a base station should use 4 subcarriers because 3 symbols are coded into 4 symbols by an STC encoder. It should be assumed that a channel suffers an insignificant change during transmission of the STC-coded symbols. This is because as the channel change is much more significant, performance of STC-decoded symbols is deteriorated, thereby causing a reduction in data rate. In order to satisfy this assumption, an embodiment of the present invention proposes the following 3 schemes as the OFDM transmission scheme can use both a time domain and a frequency domain.

A first scheme transmits the STC-coded symbols at the same time using 4 adjacent subcarriers in an OFDM symbol. Such an OFDM subcarrier modulation scheme is referred to as a “space-frequency coded OFDM (SFC-OFDM) scheme.”

A second scheme sequentially transmits 4 STC-coded symbols one by one using one subcarrier in an OFDM symbol for a continuous time period for which the OFDM symbol is transmitted. Such an OFDM subcarrier modulation scheme is referred to as a “space-time coded OFDM (SFC-OFDM) scheme.”

A third scheme sequentially arranges two of 4 STC-coded symbols, transmits the arranged 2 STC-coded symbols at the same time using 2 adjacent subcarriers in an OFDM symbol, and thereafter, sequentially arranges the remaining 2 symbols among 4 STC-coded symbols, and transmits the arranged 2 symbols using the same subcarriers for the next time. Such an OFDM subcarrier modulation scheme is referred to as a “space-time-frequency coded OFDM (SFTC-OFDM) scheme.”

With reference to the accompanying drawings, a description will now be made of the 3 modulation schemes.

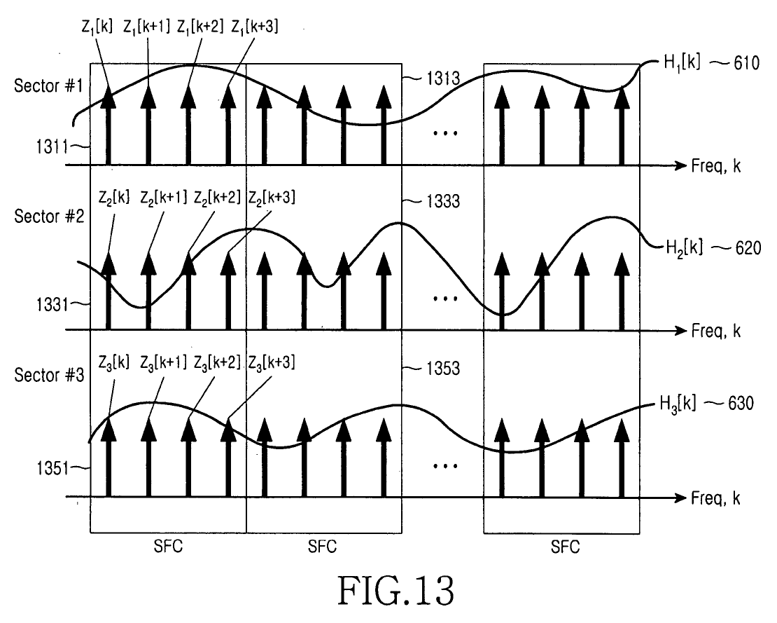

FIG. 13 is a conceptual diagram for a description of an OFDM subcarrier modulation scheme based on an SFC-OFDM scheme according to the second embodiment of the present invention.

Referring to FIG. 13, reference numerals 1311, 1331 and 1351 represent the parts where broadcast service symbols according to an embodiment of the present invention are transmitted. Reference numerals 1313, 1333 and 1353 represent subcarriers through which not the broadcast service data but general data, such as unicast data, is transmitted. A description thereof will now be made with reference to the outputs of the STC encoder of FIG. 11. As described in connection with FIG. 11, a first sector Sector#1 transmits the top-line coded symbols output from the STC encoder 1011, which are the coded symbols in the first column of Equation (4). Therefore, the 4 adjacent coded symbols are sequentially mapped to the coded symbols in the first column of Equation (4), and denoted by Z₁[k], Z₁[k+1], Z₁[k+2], and Z₁[k+3], respectively. Similarly, in a second sector Sector#2, the corresponding 4 adjacent coded symbols are sequentially mapped to the coded symbols in the second column of Equation (4), and denoted by Z₂[k], Z₂[k+1], Z₂[k+2], and Z₂[k+3], respectively. Finally, in a third sector Sector#3, the corresponding 4 adjacent coded symbols are sequentially mapped to the coded symbols in the third column of Equation (4), and denoted by Z₃[k], Z₃[k+1], Z₃[k+2], and Z₃[k+3], respectively. If the symbols to be transmitted according to this mapping rule are substituted into Equation (4), the columns are rewritten as

$$\{ Z 1 [ k ] , Z 1 [ k + 1 ] , Z 1 [ k + 2 ] , Z 1 [ k + 3 ] \} = \{ X [ m ] , - {X}^{*} [ m + 1 ] , \frac{{X}^{*} [ m + 1 ]}{\sqrt{2}} , \frac{{X}^{*} [ m + 1 ]}{\sqrt{2}} \} , \\ \{ Z 2 [ k ] , Z 2 [ k + 1 ] , Z 2 [ k + 2 ] , Z 2 [ k + 3 ] \} = \{ X [ m + 1 ] , - {X}^{*} [ m ] , \frac{{X}^{*} [ m + 2 ]}{\sqrt{2}} , \frac{{X}^{*} [ m + 2 ]}{\sqrt{2}} \} , \\ \{ Z 3 [ k ] , Z 3 [ k + 1 ] , Z 3 [ k + 2 ] , Z 3 [ k + 3 ] \} = \{ \frac{{X}^{*} [ m + 2 ]}{\sqrt{2}} , \frac{{X}^{*} [ m + 2 ]}{\sqrt{2}} , \frac{X [ m ] - {X [ m ]}^{*} + X [ m + 1 ] - {X}^{*} [ m + 1 ]}{2} , \frac{X [ m ] - {X}^{*} [ m ] + X [ m + 1 ] + {X}^{*} [ m + 1 ]}{2} \} \qquad Equation ( 5 )$$

The mapping rule between the sector outputs and the STC encoder outputs is subject to change. This is because the transmission symbols are selected according to a selection signal from the selection controller 1050 as described with reference to FIG. 10. In addition, reference numerals 1310, 1330 and 1350 represent curves for the channel functions that subcarriers experience in the corresponding sectors.

In the method of FIG. 13, if all subcarriers are used for transmitting only the broadcast data, all of the sectors can transmit the same data after STC-coding. Even though the unicast data and the broadcast data are mixedly modulated with subcarriers, only the subcarrier where the broadcast data is modulated can be selectively subject to space-time coding.

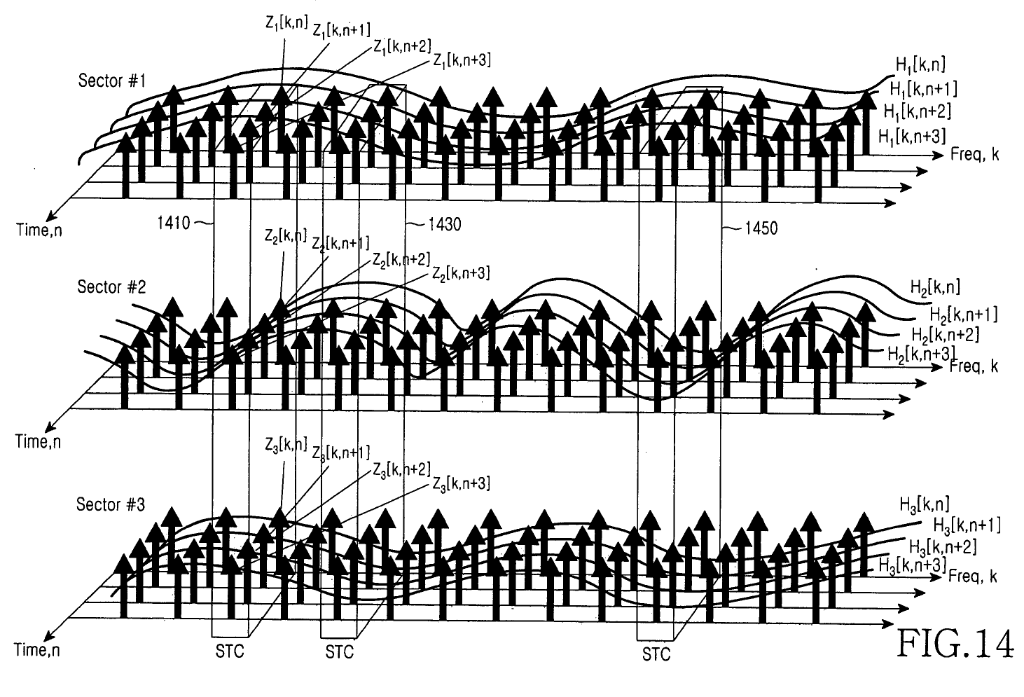

FIG. 14 is an exemplary diagram for describing an OFDM subcarrier modulation scheme based on an STC-OFDM scheme according to the second embodiment of the present invention.

Referring to FIG. 14, reference numerals 1410, 1430 and 1450 represent the parts where broadcast service symbols according to an embodiment of the present invention are transmitted. In FIG. 14, STC-coded broadcast service symbols are transmitted for a continuous time period using only one OFDM subcarrier. As described with reference to FIGS. 2 to 5, the sectors transmit different STC-coded symbols. Therefore, in order to demodulate the 3 symbols STC-coded by the STC encoder, the same subcarriers should be received for 4 continuous time periods.

The other subcarriers with no reference numeral do not transmit the broadcast service data but unicast symbols.

The broadcast service data symbols transmitted in FIG. 14 will not be described in association with the outputs of the STC encoder of FIG. 11. As described with reference to FIG. 11, in a first sector Sector#1, the top-line coded symbols output from the STC encoder 1011, which are the coded symbols in the first column of Equation (4) are sequentially transmitted for one subcarrier. That is, the coded symbols in the first column of Equation (4) are sequentially transmitted, and denoted in FIG. 14 by Z₁[k,n], Z₁[k,n+1], Z₁[k,n+2], and Z₁[k,n+3], respectively. Similarly, in a second sector Sector#2, the corresponding 4 coded symbols are sequentially mapped to the coded symbols in the second column of Equation (4), and denoted in FIG. 14 by Z₂[k,n], Z₂[k,n+1], Z₂[k,n+2], and Z₂[k,n+3], respectively. Finally, in a third sector Sector#3, the corresponding 4 coded symbols are sequentially mapped to the coded symbols in the third column of Equation (4), and denoted in FIG. 14 by Z₃[k], Z₃[k,n+1], Z₃[k,n+2], and Z₃[k,n+3], respectively. If the symbols to be transmitted according to this mapping rule are substituted into Equation (4), the columns are rewritten as

$$\{ Z 1 [ k , n ] , Z 1 [ k , n + 1 ] , Z 1 [ k , n + 2 ] , Z 1 [ k , n + 3 ] \} = \{ X [ m ] , - {X}^{*} [ m + 1 ] , \frac{{X}^{*} [ m + 1 ]}{\sqrt{2}} , \frac{{X}^{*} [ m + 1 ]}{\sqrt{2}} \} , \\ \{ Z 2 [ k , n ] , Z 2 [ k , n + 1 ] , Z 2 [ k , n + 2 ] , Z 2 [ k , n + 3 ] \} = \{ X [ m + 1 ] , - {X}^{*} [ m ] , \frac{{X}^{*} [ m + 2 ]}{\sqrt{2}} , \frac{{X}^{*} [ m + 2 ]}{\sqrt{2}} \} , \\ \{ Z 3 [ k , n ] , Z 3 [ k , n + 1 ] , Z 3 [ k , n + 2 ] , Z 3 [ k , n + 3 ] \} = \{ \frac{X [ m + 2 ]}{\sqrt{2}} , \frac{X [ m + 2 ]}{\sqrt{2}} , \frac{- X [ m ] - {X [ m ]}^{*} + X [ m + 1 ] - {X}^{*} [ m + 1 ]}{2} , \frac{X [ m ] - {X}^{*} [ m ] + X [ m + 1 ] + {X}^{*} [ m + 1 ]}{2} \} \qquad Equation ( 6 )$$

Likewise, the mapping rule between the sector outputs and the STC encoder outputs is subject to change. This is because the transmission symbols are selected according to a selection signal from the selection controller 1050 as described with reference to FIG. 10.

In the method of FIG. 14, if all subcarriers are used for transmitting only the broadcast data, all of the sectors can transmit the same data after STC-coding. Even though the unicast data and the broadcast data are mixedly modulated with subcarriers, only the subcarrier where the broadcast data is modulated can be selectively subject to space-time coding.

Now, a description will be made of a comparison between the transmission method of FIG. 13 and the transmission method of FIG. 14. In FIG. 13, 4 adjacent subcarriers are correctively STC-coded, and in FIG. 14, 4 OFDM symbols are sequentially transmitted using one subcarrier. The subcarrier modulation scheme presented in FIG. 13 can be used when there is almost no channel variation between the 4 adjacent subcarriers, while the subcarrier modulation scheme presented in FIG. 14 can be used when there is almost no channel variation between the 4 OFDM symbols, in particular, when there is almost no channel variation with the passage of time. However, in the SFC-OFDM scheme of FIG. 13, if a delay spread of a channel is great, there is a possibility that the channel variation will occur between continuous STC-coded symbols, thereby deteriorating the system performance. In the STC-OFDM scheme of FIG. 14, there is the possibility that the channel variation will occur between continuous STC-coded symbols in a fast fading channel environment, thereby deteriorating the system performance.

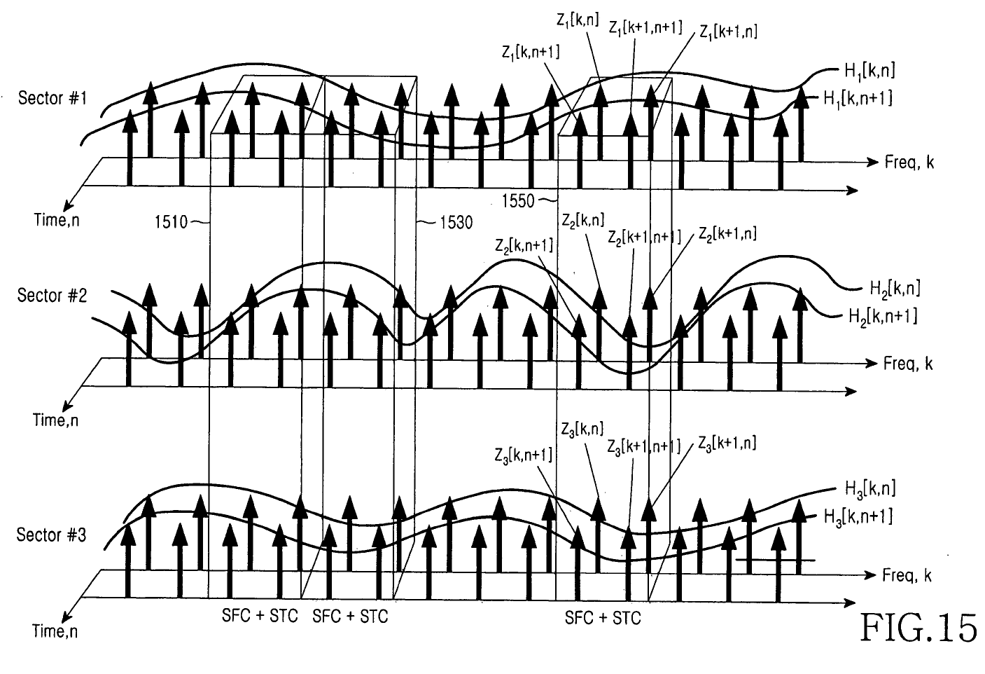

FIG. 15 is an exemplary signal diagram for describing an OFDM subcarrier modulation scheme based on an SFTC-OFDM scheme according to the second embodiment of the present invention. In FIG. 15, reference numerals 1510 and 1550 represent symbols for STC-coded broadcast service data, and reference numeral 1530 represents unicast data symbols. As illustrated in FIG. 15, 2 symbols among STC-coded broadcast data symbols are transmitted using 2 adjacent subcarriers transmitted with one frequency, and the remaining 2 symbols among the STC-coded broadcast data symbols are for the next time using the same symbols. For the transmission symbols, the data transmitted through a first sector Sector#1 is denoted in FIG. 15 by Z₁[k,n], Z₁[k+1,n], Z₁[k,n+1], and Z₁[k+1,n+1]. Similarly, in a second sector Sector#2, another set of symbols obtained by STC-coding the same symbols are transmitted, and denoted in FIG. 15 by Z₂[k,n], Z₂[k+1,n], Z₂[k,n+1], and Z₂[k+1,n+1]. Finally, in a third sector Sector#3, further another symbols obtained by STC-coding the same symbols are transmitted, denoted in FIG. 15 by Z₃[k,n], Z₃[k+1,n], Z₃[k,n+1], and Z₃[k+1,n+1].

This transmission scheme makes up for possible defects of the SFC-OFDM scheme and the STC-OFDM scheme described with reference to FIGS. 6 and 7, by transmitting STC-coded symbols over two adjacent subcarriers and two adjacent OFDM symbols. If the symbols to be transmitted according to this mapping rule are substituted into Equation (4), the columns are rewritten as

$$\{ Z 1 [ k , n ] , Z 1 [ k + 1 , n ] , Z 1 [ k + 1 , n + 1 ] \} = \{ X [ m ] , - {X}^{*} [ m + 1 ] , \frac{{X}^{*} [ m + 1 ]}{\sqrt{2}} , \frac{{X}^{*} [ m + 1 ]}{\sqrt{2}} \} , \\ \{ Z 2 [ k , n ] , Z 2 [ k + 1 , n ] , Z 2 [ k , n + 1 ] , Z 2 [ k + 1 , n + 1 ] \} = \{ X [ m + 1 ] , - {X}^{*} [ m ] , \frac{{X}^{*} [ m + 2 ]}{\sqrt{2}} , \frac{{X}^{*} [ m + 2 ]}{\sqrt{2}} \} , \\ \{ Z 3 [ k , n ] , Z 3 [ k + 1 , n ] , Z 3 [ k , n + 1 ] , Z 3 [ k + 1 , n + 1 ] \} = \{ \frac{X [ m + 2 ]}{\sqrt{2}} , \frac{X [ m + 2 ]}{\sqrt{2}} , \frac{- X [ m ] - {X [ m ]}^{*} + X [ m + 1 ] - {X}^{*} [ m + 1 ]}{2} , \frac{X [ m ] - {X}^{*} [ m ] + X [ m + 1 ] + {X}^{*} [ m + 1 ]}{2} \} \qquad Equation ( 7 )$$

Therefore, the broadcast service data transmission method of FIG. 15 is superior in STC coding performance to the broadcast service data transmission method of FIG. 13 or 7 even in a high-delay spread channel environment or a fast fading channel environment.

In the method of FIG. 15, if all subcarriers are used for transmitting only the broadcast data, all of the sectors can transmit the same data after STC-coding. Even though the unicast data and the broadcast data are mixedly modulated with subcarriers, only the subcarrier where the broadcast data is modulated can be selectively subject to space-time coding.

When the methods of FIGS. 7 and 8 are used, the selectors and the selection controller 1050 of FIG. 10 should perform more calculations as compared with when the method of FIG. 13 is used. More specifically, in the case of FIG. 14, sequential transmission is performed using one subcarrier. Selection for this method is made by the selection controller 1050 and the selection result can be transmitted through a selection signal. If a selection signal is output such that the broadcast service data is transmitted in the method of FIG. 14, the selector 1013 stores the selected symbols of the STC encoder in its internal buffer (not shown). Thereafter, the selector 1013 sequentially transmits the stored symbols, thereby achieving the transmission method of FIG. 14.

Similarly, when the broadcast service data is transmitted in the method of FIG. 15, selection of the transmission method is made by the selection controller 1050. Likewise, in the transmission method of FIG. 15, because symbols are transmitted for 2 continuous time periods, some of transmission symbols from among the coded symbols output from the STC encoder are stored, and the stored symbols can be transmitted at the next time.

As can be understood from the foregoing description, broadcast service data is transmitted using an OFDM scheme, the same broadcast services are transmitted in different sectors, and data transmitted in different sectors is coded using different STC coding methods. By doing so, a mobile station located in the vicinity of a sector boundary can obtain sector diversity.

The third embodiment of the present invention will now be described in detail with reference to FIGS. 16 to 28.

FIG. 16 is a block diagram illustrating a structure of a wireless mobile communication system to which an OFDM symbol transmission method providing sector diversity according to the third embodiment of the present invention is applied. It is assumed in FIG. 16 that the wireless mobile communication system has a multicell/multisector structure and is designed to transmit signals using the OFDM transmission scheme. It is also assumed in the system of FIG. 16 that the same data can be transmitted from the different cells or sectors like in a broadcast system.

In FIG. 16, Sector#1 to Sector#M represent devices for distinguishing different base stations or a plurality of sectors belonging to the same base station. Each of base stations (BSs) 400₁ to 400_{M} comprises an STC encoder 1611 for STC-encoding input complex symbols such that space-time code streams are transmitted per sector according to a specific pattern predetermined for each cell, a selector 1613 for selecting a space-time code stream according to the determined pattern, an inverse fast Fourier transform block (IFFT) 1615 for performing IFFT on the selected space-time code stream output from the selector 1613, and a CP attacher 440. Such a configuration is based on the fact that even the sectors belonging to different base stations (BSs) 400₁ to 400_{M} can transmit the same data to a mobile station (MS) 1650 under the control of a base station controller (not shown).

When a pattern formed by the space-time code streams is changed per cell, it is also possible to select and transmit the space-time code stream per cell. In an embodiment of the present invention, the pattern is changed to a scheme of selecting space-time code streams transmitted per cell/sector in different ways according to predetermined time periods, thereby improving sector diversity in a cell/sector boundary. A detailed description of the pattern formed by the space-time code streams will be provided later.

The process of selecting and transmitting space-time code streams per cell/sector according to the pattern formed per at least one cell uniforms cell/sector diversity in a cell/sector boundary. Herein, the sector diversity refers to cell diversity. That is, the diversity achieved in both a base station having an omni-directional antenna and a base station having a sector antenna is called the sector diversity, and the sector diversity and the cell diversity will not be separately stated unless especially needed.

In this context, when the same data is simply transmitted through different sectors, the mobile station cannot acquire a sufficient diversity gain in a cell/sector boundary as described with reference to Equation (2). Therefore, the base station 400 comprises the STC encoder 1611, the selector 1613 and the selection controller 1630, all of which are designed to provide a uniform sector diversity gain in the cell/sector boundary while transmitting the same data.

FIG. 16 shows only the elements needed for a description of the present invention, and the elements not shown in FIG. 16 will be described in brief or will not be described for conciseness.

Assuming that the mobile communication system of FIG. 16 is a broadcast system supporting a broadcast service, each base station 400 transmits the same broadcast data. Generally, because a synchronous CDMA mobile communication system transmits broadcast data to the base station 400 via a base station controller (BSC) (not shown), it can transmit the same broadcast service to each base station. In addition, a mobile communication system capable of providing a broadcast service can receive broadcast data via a packet data service node (PDSN) (not shown). Therefore, it is also possible to enable the PDSN to transmit the same broadcast service data to each base station. Alternatively, upon receiving broadcast data from the PDSN, a packet control function (PCF) (not shown), located in the same or higher layer of the base station controller, can transmit the same broadcast data to each base station.

Because it is preferable that the base station controller among the foregoing elements (base station controller, PDSN and PCF) transmits the same broadcast data, it will be assumed herein that the same broadcast data is received from the base station controller. Therefore, each base station 400 performs a procedure for transmitting the same broadcast data. It is assumed in FIG. 16 that broadcast data processed by each base station 400 is the same broadcast data. In addition, each base station 400 performs the same process of processing complex symbols X[k] input as broadcast data. Although it is assumed in FIG. 16 that X[k] is a complex symbol, the X[k] can be one of (1) a symbol subjected to channel coding and modulation, to be transmitted over a radio channel, (2) a symbol subjected to either channel coding or modulation, and (3) raw broadcast data. For convenience, it will be assumed herein that X[k] is the complex symbol subjected to channel coding and modulation.

Upon receiving the complex symbols X[k], STC encoder 1611 of FIG. 16 STC-encodes the input complex symbols according to the Alamouti space-time coding scheme before performing inverse fast Fourier transform (IFFT) on transmission data and transmitting the IFFT-processed data to each of the sectors.

The complex symbols input to the STC encoder 1611 are arranged per adjacent subcarriers in the case where the space-time coding is performed in a space and frequency domain, and arranged per OFDM symbol interval in the case where the space-time coding is performed in a space and time domain. To this end, although not illustrated in FIG. 16, it is preferable to arrange an arrangement buffer for arrangement of the complex symbols in a front stage of the STC encoder 1611.

The selector 1613 selects one of a plurality of space-time code streams acquired through the space-time coding, and transmits the selected space-time code stream to a corresponding sector. Herein, the selector 1613 selects a designated one of the space-time code streams outputs from the STC encoder 1611 at stated periods under the control of a selection controller 1630 and outputs the selected space-time code stream to the IFFT 1615. Although it is preferable that the selection controller 1630 is included in the base station controller (not shown) so that it controls the selector 1613 included in each OFDM symbol transmission device 400, the selection controller 1630 can be either combined with the selector 1613 or separately included in each base station 400. Alternatively, the selection controller 1630 can be included in the PDSN or the PCF located in the upper layer of the base station controller.

Alternatively, the STC encoder and the selector can be included in the base station controller. In this case, the coded symbols output from the STC encoder are input to selectors associated with the base stations. The selectors associated with the base stations transmit the coded symbol streams selected depending on a control signal from the selection controller, to their associated base stations. When the STC encoder and the selector are included in the base station controller in this way, data transmitted to each base station is STC-encoded data. In this case, the amount of data to be transmitted between the base station and the base station controller can be greater than or equal to that in the case where the space-time coding is not performed. Therefore, whether the selector should be included in the base station controller or the base station can be determined considering the cost of a link occupied between the base station controller and the base station and the cost of related devices.

In contrast, only the STC encoder and the selection controller can be installed in the base station controller. In this case, each base station can include its own selector and the base station controller transmits the overall coded symbol streams encoded in the STC encoder to each base station. Therefore, this method increases the amount of data to be transmitted between the base station and the base station controller, decreasing data transmission efficiency. Another method can determine STC-encoded symbol streams to be transmitted by a cell/sector of each base station in a predetermined manner when installing the base stations. In this case, the selection controller is unnecessary, and this method can be implemented by designing the selector such that it outputs only predetermined symbols.

In the following description, it will be assumed that the selection controller 1630 is included in the base station controller and each selector is included in its associated base station 400. The selection controller 1630 controls the selector 1613 of each base station 400 such that different space-time code streams can be transmitted to at least one cell/sector formed by the same or different base stations. In the present invention, the space-time code streams formed by the base stations have a predetermined pattern and the pattern circulates at predetermined periods as will be described later with reference to FIGS. 6 to 11. Therefore, the selection controller 1630 is provided to change the symbols selected from among the coded symbols output from the STC encoder 1611, and to indicate a change period of the pattern at the sectors/cells formed by each base station. This is to enable a mobile station receiving a broadcast service, located in the vicinity of a base station, to distinguish coded symbols for the broadcast service received from the base stations. In this manner, a sector enables a mobile station receiving a broadcast service, located in the vicinity of a base station, to receive symbol streams for the same broadcast service, encoded in different ways, thereby making it possible for the mobile station to acquire diversity.

The present invention provides two embodiments: one embodiment in which the space-time coding for the OFDM transmission scheme is performed in a space and frequency domain, and another embodiment in which the space-time coding for the OFDM transmission scheme is performed in a space and time domain. When the space-time coding is performed in the space and time domain, it is possible to arrange, as between the selector 1613 and the IFFT 1615, an arrangement buffer (not shown) for arrangement of the complex symbols input to the STC encoder 1611, designed such that it transmits a space-time code stream selected from among the space-time code streams to the mobile station through a plurality of adjacent OFDM symbols, and a rearrangement buffer (not shown) for rearrangement of the selected space-time code stream such that it transmits the selected space-time code stream to a corresponding sector through the adjacent OFDM symbols.

The IFFT 1615 performs IFFT on data to be transmitted to the mobile station 1650 to convert the transmission data into time-domain data, and outputs the IFFT-processed data to a CP attacher 440. The CP attacher 440 attaches a cyclic prefix symbol (CP) to the IFFT-processed OFDM data and outputs an OFDM symbol. The OFDM symbol is transmitted to a corresponding one of the sectors Sector#1 to Sector#M via an antenna 1619.

In the structure of FIG. 16, if a transmitter of the base station performs a modulation process using IFFT, a receiver of the mobile station performs a demodulation process using fast Fourier transform (FFT). Alternatively, the transmitter of the base station can perform the modulation process using FFT, and in this case, the receiver of the mobile station performs the demodulation process using IFFT. For convenience, it will be assumed herein that the IFFT and the FFT are used for modulation and demodulation, respectively, as shown in FIG. 16.

Herein, the STC encoder 1611 uses the Alamouti space-time coding scheme, and is designed to receive two complex symbols and output two different coded symbol streams, i.e., space-time code streams, and its coding matrix C is defined as a 2×2 matrix shown in Equation (3).

The STC encoder 1611 outputs two different space-time code streams in accordance with Equation (3).

Under the control of the selection controller 1630, the space-time code streams output to a plurality of cells and/or sectors have a specific pattern. The selection controller 1630 updates the selected space-time code stream every predetermined update interval which is set periodically or aperiodically, such that uniform sector diversity gains occur in all of the mobile stations. When the update interval is periodically set, it will be called an update period.

It should be noted in FIG. 16 that the receiver of the mobile station 1650 can restore data using one STC decoder regardless of a change in the space-time code stream. That is, in FIG. 16, the mobile station 1650 receives OFDM symbols transmitted from a sector boundary, via an antenna 1651. In the mobile station 1650, a CP remover 1653 detaches a CP from the received OFDM symbol, and delivers the CP-detached OFDM symbol to a fast Fourier transform block (FFT) 1655. The FFT 1655 performs fast Fourier transform on the OFDM symbol to convert the OFDM symbol into a frequency-domain signal, and outputs the FFT-processed OFDM symbol to an STC decoder 1657. The STC decoder 1657 decodes the FFT-processed OFDM symbol into the original space-time code stream using the Alamouti space-time coding scheme.

Given that the Alamouti space-time code has a coding rate of 1, the STC decoder 1657 can decode data without a loss of a data rate in a region adjacent to the base station 400, not in a sector boundary. In the sector boundary, the STC decoder 1657 obtains a sector diversity gain by receiving STC-encoded signals from the base stations 400 in the different sectors. Therefore, the mobile station 1650 does not require a position information decoding process, making it possible to efficiently increase the overall cell capacity without a separate device.

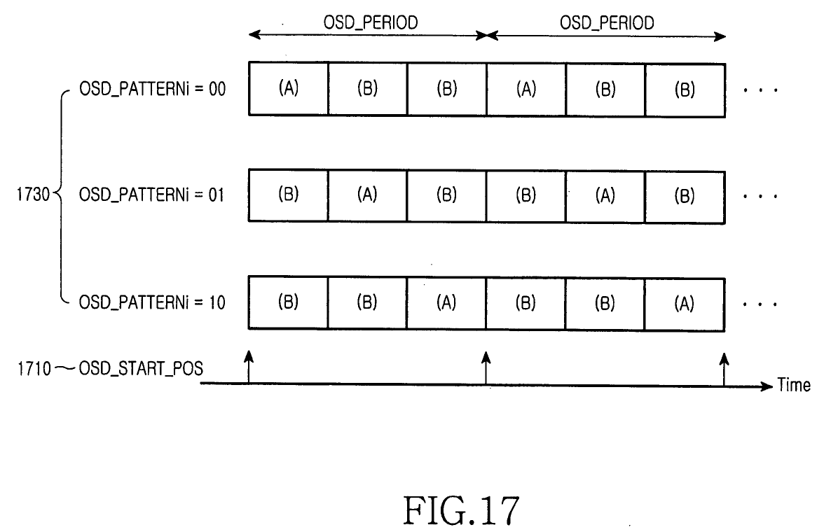

With reference to FIG. 17, a detailed description will now be made of an update period and a transmission pattern of space-time code streams selected by the selector 1613 under the control of the selection controller 1630.

FIG. 17 is a diagram illustrating an update period and a transmission pattern of space-time code streams transmitted from a base station to a mobile station according to the third embodiment of the present invention. As illustrated in FIG. 17, space-time code streams output from an STC encoder change in transmission pattern (OSD_PATTERN) every update period (OSD_PERIOD). The update period of the transmission pattern is a multiple of 3 times the period for which IFFT or FFT is performed, and can be expressed as Equation (8) below.
OSD_PERIOD=3P×IFFT period (or FFT period) (8)
where P is an integer larger than or equal to 1.

In FIG. 17, the P is 1, by way of example. Each base station receives a corresponding one of control signals S₁ to S_{M} for selecting space-time code streams, output from the 10 selection controller 1630. The control signals S₁ to S_{M} can be configured in various forms according to a space-time code stream selection method of each base station. For example, when there are only 2 types of transmission patterns which are updated at predetermined periods, only a control signal indicating a start of the corresponding operation can be transmitted. Alternatively, a control signal that alternates between ‘0’ and ‘1’ according to a determined transmission pattern can be transmitted.

Each base station generates an update start position signal (OSD_START_POS) 1710 synchronized between base stations per update period OSD_PERIOD of the transmission pattern received from the selection controller 1630. In addition, the base station selects a space-time code stream to be transmitted to the mobile station, based on the transmission pattern signal OSD_PATTERNi provided from the selection controller 1630. The update start position signal OSD_START_POS has a period of OSD_PERIOD and can indicate a start point of the OSD_PATTERNi.

In the embodiment of FIG. 17, the control signals S₁ to S_{M} each comprise the update period signal OSD_PERIOD and/or the transmission pattern signal OSD_PATTERNi (1730).

For example, the transmission pattern signal 1730 is comprised of 2 bits. An ‘i’ value in the OSD_PATTERNi indicates an index of a base station (cell) or a sector. Because the mobile communication system generally has a 3-sector structure, FIG. 17 is given for a description of patterns for 3 sectors formed by one base station. If 2 bits are used for the transmission pattern signal 1730, 3 different transmission patterns can be formed.

The transmission patterns illustrated in FIG. 17 comprise the following:
(1) OSD_PATTERNi=00, in which space-time code streams are arranged in the order of (A)→(B)→(B)
(2) OSD_PATTERNi=01 in which space-time code streams are arranged in the order of (B)→(A)→(B)
(3) OSD_PATTERNi=10 in which space-time code streams are arranged in the order of(B)→(B)→(A)

Herein, (A) and (B) correspond to the symbol streams illustrated in the space-time code streams of FIGS. 4A and 4B. That is, (A) corresponds to the upper row of Equation (3) and (B) corresponds to the lower row.

Although it is shown in FIG. 17 that the number of symbol streams corresponding to (A) from among the symbol streams output from the STC encoder is less than the number of symbol streams corresponding to (B), the same effect can be obtained even though the number of symbol streams corresponding to (A) is greater than the number of symbol streams corresponding to (B). The OSD_PATTERNi=00 will be described on the assumption that a period for which symbol streams illustrated in FIG. 17 are output is one IFFT period or one FFT period. In this case, for one transmission pattern update period OSD_PERIOD, the symbol streams (A) are transmitted for one IFFT period and thereafter, the symbol streams (B) are transmitted for two IFFT periods. On the contrary, however, the same effect can be obtained even though the symbol streams (B) are transmitted for one IFFT period and thereafter, the symbol streams (A) are transmitted for two IFFT periods. In this case, the same change should be made even in the other transmission patterns. That is, the transmission patterns and the transmission pattern update periods illustrated in FIG. 17 are given by way of example.

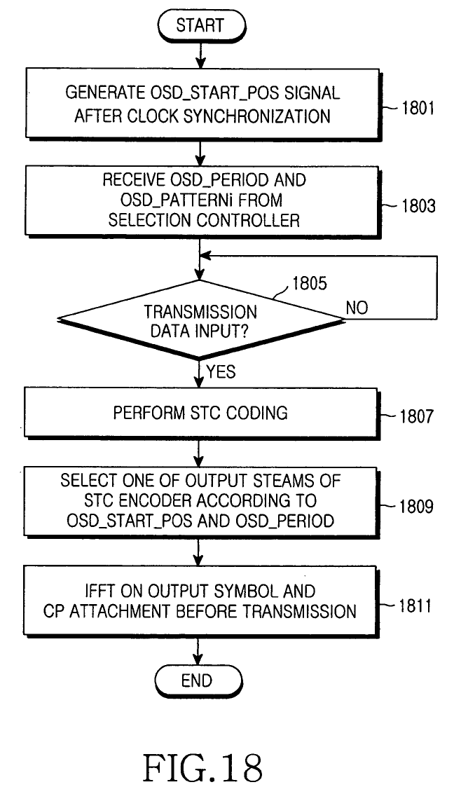

FIG. 18 is a flowchart illustrating an OFDM symbol transmission method according to the third embodiment of the present invention. Specifically, FIG. 18 illustrates an operation of a base station performed when a selection controller transmits an update period and a transmission pattern of space-time code streams to a selector for each base station as a control signal as illustrated in FIG. 17.

Referring to FIG. 18, in step 1801, each base station generates an update start position signal OSD_START_POS (1710) as shown in FIG. 17 by synchronizing with a clock used in each sector. Generally, in the synchronous CDMA mobile communication system, because all base stations are synchronized with each other, the process of acquiring synchronization between base stations may not be required. However, in the asynchronous WCDMA mobile communication system, because base stations are not synchronized with each other, the process of acquiring synchronization between base stations is required. In this manner, each base station acquires sector synchronization and then generates the update start position signal. In addition, the selection controller 1630 in the base station controller generates the transmission pattern signal OSD_PATTERNi (1730) to be output to each base station or sector. The update start position signal, as illustrated in FIG. 17, is generated only at the time when the signal is needed, and the pattern signal can be generated continuously or only at the time when the signal is required.

In step 1803, a selector 1613 of each base station previously receives an update period signal OSD_PERIOD and a transmission pattern signal OSD_PATTERNi (1730) from the selection controller 1630 as parameters for controlling an output of the space-time code streams. The update start position signal OSD_START_POS generated in step 1801 has a period of the OSD_PERIOD, and indicates a start position of the OSD_PATTERNi. Thereafter, in step 1805, the base station determines if there is any input transmission data in an STC encoder. In the case where transmission is achieved for each sector according to the geometry or coverage of the base station, the base station can determine whether there is any transmission data, per corresponding sector. In the case where transmission is performed per base station, the base station determines if there is any transmission data, per base station.

If it is determined in step 1805 that there is transmission data, the base station proceeds to step 1807 where it performs space-time coding by controlling the STC encoder 1611. The space-time code streams subjected to the space-time coding are input to each selector 1613 included in each base station or a transmitter for each sector of the base station. In step 1809, each selector 1613 selects the output space-time code streams based on the update period signal OSD_PERIOD and the transmission pattern signal OSD_PATTERNi received from the selection controller 1630 included in the base station controller. The space-time code streams selected in each base station or each sector of the base station are transmitted to a wireless network via an IFFT 1615 and a CP attacher 440 in step 1811.

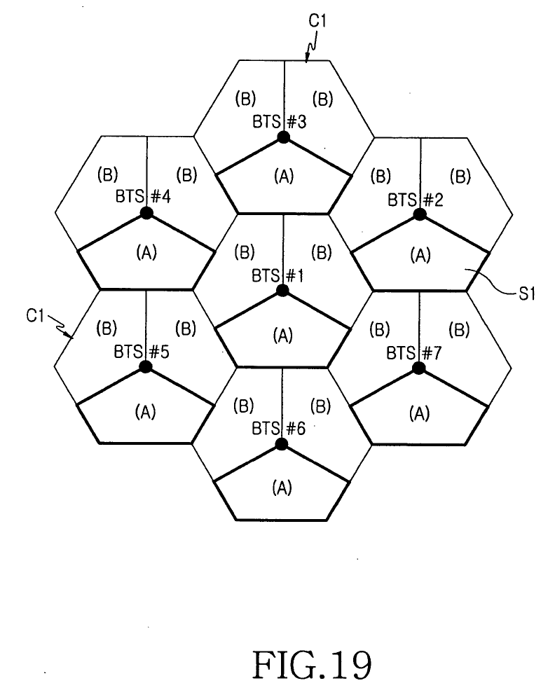

With reference to FIGS. 19 to 24, a description will now be made of a per-sector/cell space-time code stream arrangement method proposed in the present invention to acquire sector diversity.

FIGS. 19 to 21 are diagrams for a description of a per-sector space-time code stream arrangement method according to an embodiment of the present invention, wherein one cell C1 has a 3-sector structure S1.

The space-time code stream arrangement of FIGS. 19 to 21 is performed under the control of the selection controller 1630 of FIG. 16, and the space-time code streams output to each sector C1 in this manner have a specific pattern. The pattern, as shown in FIG. 17, can be formed by an operation of each selector 1613 performed based on the update period signal OSD_PERIOD and the transmission pattern signal OSD_PATTERNi (1730) provided from the selection controller 1630. In FIGS. 19 to 21, BTS#1 to BTS#7 represent base stations each forming 3 sectors, and (A) and (B) represent two space-time code streams {X₁, X₂} and {−X₂*, X₁*} or {X₁, −X₂*} and {X₂, X₁*}, respectively, output from the STC encoder 1611 described in connection with FIGS. 4A and 4B.

If the selection controller 1630 of FIG. 16 transmits a corresponding one of the control signals S₁, S₂, . . . , S_{M} to the selector 1613 belonging to each sector, the selector 1613 outputs a selected one of the time-space code streams (A) and (B) based on the corresponding control signal. In each sector, space-time code streams to be transmitted in the sector are selectively output as shown in FIGS. 19 to 21 according to a corresponding one of the control signals S₁, S₂, . . . , S_{M}, forming a specific per-cell pattern, and the pattern is changed for each update interval of the space-time code stream, thereby providing uniform sector diversity to the mobile station. In FIG. 17, the control signals S₁, S₂, . . . , S_{M} each include an update period signal OSD_PERIOD and a transmission pattern signal OSD_PATTERNi (1730).

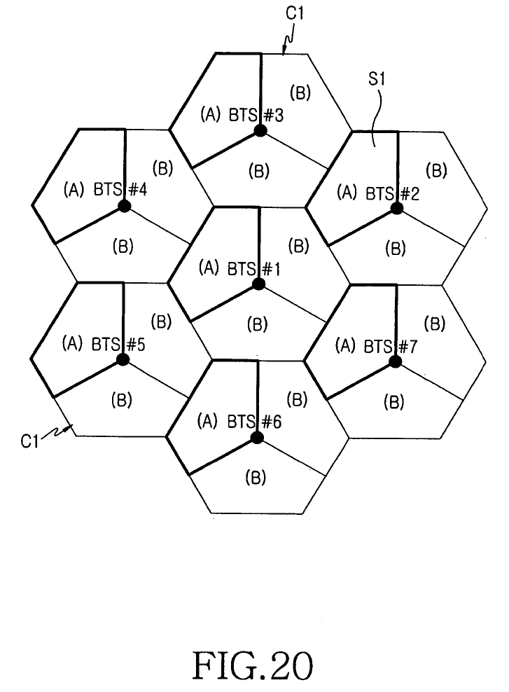

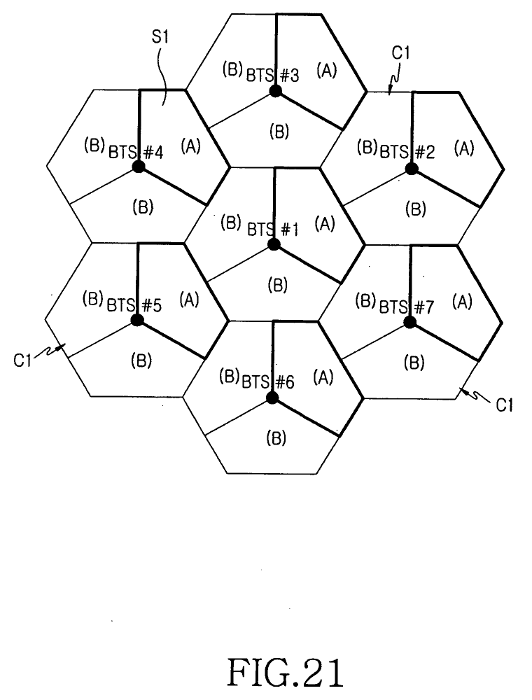

In FIGS. 19 to 21, each of the base stations BTS#1 to BTS#7 forms an output pattern of the same space-time code streams per cell by outputting the space-time code stream (A) to one sector and outputting the space-time code stream (B) to the other two sectors. The section controller 1630 controls the selector 1613 such that for an aperiodical update interval or a periodical update period, an output pattern of space-time code streams is updated in the cyclic order of FIG. 19→FIG. 20→FIG. 21→FIG. 19 or FIG. 19→FIG. 21→FIG. 20→FIG. 19. Herein, such a space-time code stream output scheme will be referred to as a “circular selection control scheme” or “circular space-time code selection scheme.”

In FIGS. 19 to 21, a full sector diversity gain occurs in a boundary between a sector where the space-time code stream (A) is transmitted and a sector where the space-time code stream (B) is transmitted, and the bold lines represent the sector boundaries where the full sector diversity gain occurs. Therefore, if output of the space-time code streams is controlled with the circular selection control scheme, the position of the sector boundary where sector diversity occurs is periodically changed, so that uniform sector diversity gains can be provided to all mobile stations in the sector boundary. That is, in the sector boundary, the same data from the sectors is transmitted using different coding methods, so that the mobile station can distinguish at least 2 signals. Therefore, the mobile station can separately receive the input data, making it possible to obtain a sector diversity gain.

If the circular space-time code selection scheme is used, there is no region where the sector diversity effect cannot be continuously obtained, so that the sector diversity effect accumulated for a long time becomes equal in every region. From a point of the base station's view, if the base station cannot be located in a particular sector region or there is a very low probability that the base station will be located in the particular sector region, the circular scheme can be changed so that the sector diversity effect cannot be obtained in the corresponding sector. The change in the circular scheme depends upon a geographical condition of the position where the base station is located.

Although the pattern shown in FIGS. 19 to 21 is formed such that in each cell, one sector outputs the space-time code stream (A) and the other two sectors output the space-time code stream (B), the same sector diversity can be obtained with a pattern formed such that one sector outputs the space-time code stream (B) and the other two sectors output the space-time code stream (A).

As another example of the per-sector space-time code stream arrangement method, there is a possible method of periodically changing an output pattern of the space-time code streams in the order of FIG. 19→FIG. 20→FIG. 19, in the order of FIG. 20→FIG. 21→FIG. 20, or in the order of FIG. 19→FIG. 21→FIG. 19. Although this method can provide improved sector diversity as compared with the conventional method, it cannot obtain sufficient sector diversity compared with the circular selection control scheme, causing some performance deterioration.

With reference to FIGS. 5 and 19 to 21, if a first update period of each pattern expires, the next pattern is transmitted. Describing this on the foregoing assumption, a period for which one symbol stream is selected and output becomes one IFFT period or one FFT period. This period can be a multiple of the IFFT period or the FFT period. After outputting the symbol streams selected for the predetermined period, the base station changes the output of the corresponding sectors. That is, the base station changes the pattern in the order of FIG. 19→FIG. 20→FIG. 21 on a circular basis.

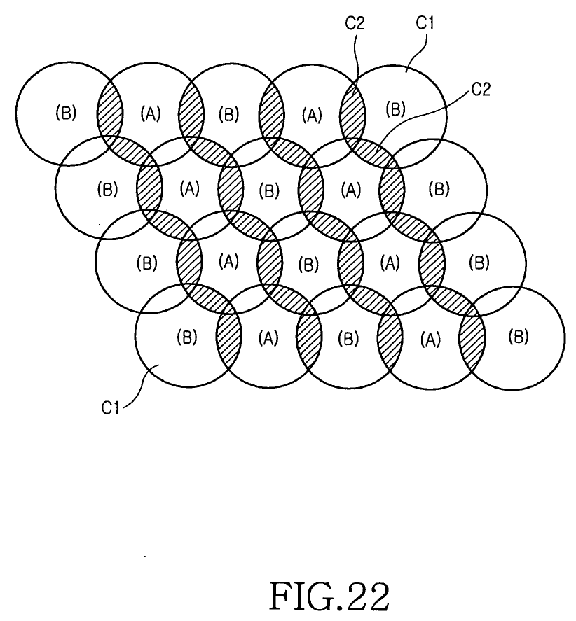

FIGS. 22 to 24 are diagrams for a description of a per-cell space-time code stream arrangement method according to an embodiment of the present invention, wherein each cell C1 transmits space-time code streams per cell using an omni-directional antenna without sectorization. The space-time code stream arrangement of FIGS. 22 to 24 is also performed under the control of the selection controller 1630, and the space-time code streams output to a plurality of cells C1 in this manner have a specific pattern. In FIGS. 22 to 24, (A) and (B) represent two space-time code streams {X₁, X₂} and {−X₂*, X₁*} or {X₁, −X₂*} and {X₂, X₁*}, respectively, output from the STC encoder 1611 described in connection with FIGS. 4A and 4B, and regions C2 with oblique lines represent the regions where the full cell diversity gain occurs.

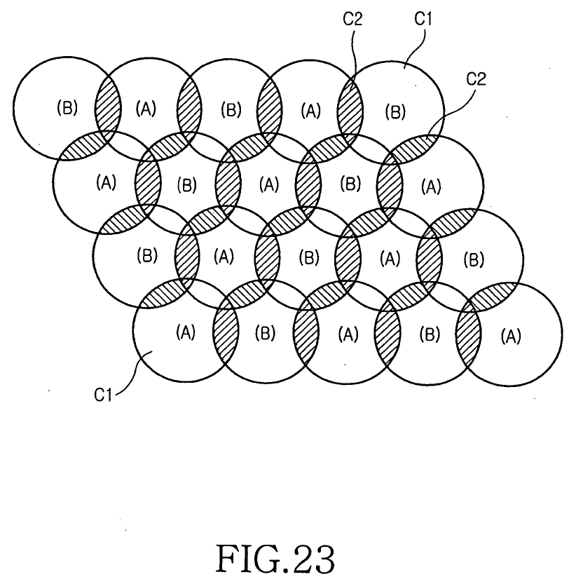

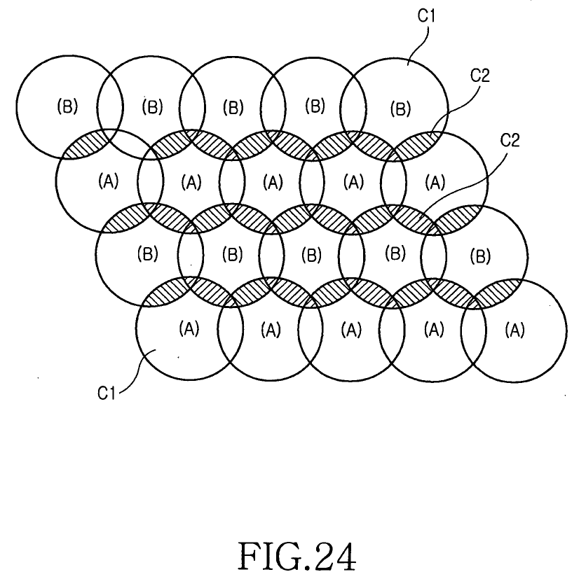

To form the patterns of FIGS. 22 to 24, the selection controller 1630 controls a selector 1613 of a base station that forms each cell C1 to select one of the space-time code streams (A) and (B) in the order of FIG. 22→FIG. 23→FIG. 24→FIG. 22 or FIG. 22→FIG. 24→FIG. 23→FIG. 22 every aperiodical update period or periodic update period so that an output pattern of the space-time code streams is updated on a circular basis. Therefore, it can be understood that if output of the space-time code streams is controlled by the circular selection control scheme, all mobile stations located in the cell boundary have the same cell diversity gain on average. In addition, even though each cell changes output of the space-time code stream (A) or (B) in FIGS. 22 to 24, the same cell diversity can be obtained.

As another per-cell space-time code stream arrangement method using an omni-directional antenna, there is a possible method of changing an output pattern of the space-time code streams in the order of FIG. 22→FIG. 23→FIG. 22, in the order of FIG. 23→FIG. 24→FIG. 23, or in the order of FIG. 22→FIG. 24→FIG. 22 every update period. Although this method can provide improved sector (cell) diversity as compared with the conventional method, it cannot obtain sufficient sector (cell) diversity compared with the circular selection control scheme, causing some performance deterioration.

It should be noted that when the per-sector/cell space-time code stream arrangement method is performed, there is no need to transmit a separate control signal to a mobile station and the mobile station can restore received data using one STC decoder. Alternatively, however, the base station can transmit a separate control signal to the mobile station to assist an STC decoding process of the mobile station. For example, the base station can transmit information on an update period OSD_PERIOD to the mobile station over a signaling channel, and the mobile station can perform channel estimation and STC decoding using the received information on the update period STD_PERIOD. Alternatively, the base station can transmit information on an update period OSD_PERIOD and a transmission pattern signal OSD_PATTERNi to the mobile station over a signaling channel, and the mobile station can perform channel estimation and STC decoding using the received information on the update period STD_PERIOD and the transmission signal pattern OSD_PATTERNi received from its adjacent base station.

Given that the Alamouti space-time code has a coding rate of 1, the mobile station can decode data without a loss of a data rate in a region adjacent to the base station, not in a sector/cell boundary. In the sector/cell boundary, the mobile station obtains a sector/cell diversity gain because it receives space-time code streams from different sectors/cells. Because an output pattern of the space-time code streams is circulated by the circular selection control scheme, all mobile stations in the sector/cell boundary can obtain the same sector/cell diversity gain on average, maximizing the overall cell throughput.

In order to transmit the space-time code streams, a variation in channel should be insignificant during transmission of each code stream. This is because an increase in the channel variation reduces orthogonality of the space-time code streams, causing deterioration of STC decoding performance at the mobile station and decreasing a data rate. In order to satisfy the hypothesis, the present invention provides one scheme of transmitting space-time code streams using two adjacent subcarriers in an OFDM symbol and another scheme of transmitting space-time code streams using one subcarrier for a period of two adjacent OFDM symbols, based on the fact that the OFDM transmission scheme can use both a time domain and a frequency domain. Herein, the former scheme of transmitting space-time code streams with two adjacent subcarriers will be referred to as a “Space-Frequency Coded OFDM (SFC-OFDM) scheme,” and the latter scheme of transmitting space-time code streams for a period of two adjacent OFDM symbols will be referred to as a “Space-Time Coded OFDM (STC-OFDM) scheme.”

Now, an OFDM symbol transmission method based on the SFC-OFDM scheme will be described with reference to FIGS. 13 and 14, and thereafter, an OFDM symbol transmission method based on the STC-OFDM scheme will be described with reference to FIGS. 15 and 16.

For reference, in FIGS. 14 and 16, block arrows represent subcarriers with which space-time code streams for broadcast data are modulated, and white arrows represent subcarriers with which space-time code streams for unicast data are modulated. Sector#1 and Sector#2 represent sectors (FIGS. 19 to 21) or cells (FIGS. 22 to 24), each of which selectively transmits one of the space-time code streams (A) and (B) of FIGS. 19 to 24. As described above, Sector#1 and Sector#2 can correspond to different base stations. H₁[k] and H₂[k] represent channel components (channel functions) of signals transmitted from a 1^{st} sector/cell and a 2^{nd} sector/cell through a k^{th} subcarrier, respectively.

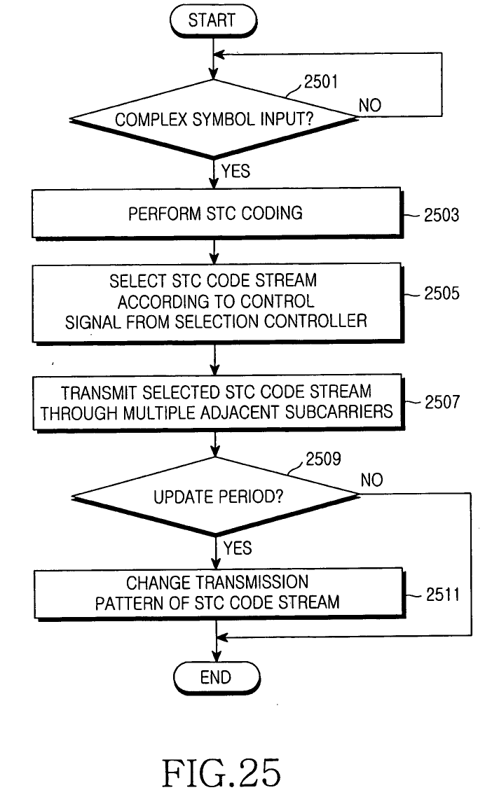

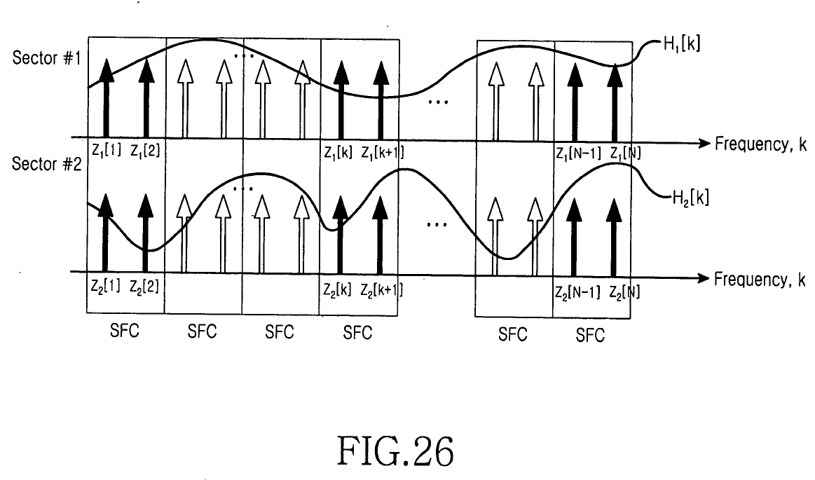

FIG. 25 is a flowchart illustrating an OFDM symbol transmission method based on an SFC-OFDM scheme according to the third embodiment of the present invention, and FIG. 26 is a diagram illustrating a process of transmitting space-time code streams in the method of FIG. 25.

Referring to FIG. 25, in step 2501, assuming that broadcast data or unicast symbols to be modulated with N subcarriers in each base station is defined as X[k], where k=1, 2, . . . , N, the broadcast data is demultiplexed per two complex symbols X(k) and X(k+1) and input to an STC encoder 1611. In step 2503, the STC encoder 1611 receiving the two complex symbols X(k) and X(k+1), STC-encodes the two complex symbols X(k) and X(k+1) according to the Alamouti space-time coding scheme such that the space-time code streams of FIG. 4A or FIG. 4B are output through the coding matrix C of Equation (3).

In step 2505, a selection controller 1630 outputs control signals S₁ to S_{M} to their associated selectors 1613 such that the per-sector transmission patterns of FIGS. 19 to 21 and/or the per-cell transmission patterns of FIGS. 22 to 24 should be formed, and each of the selectors 1613 receiving their control signals S₁ to S_{M} selects one of two space-time code streams (A) and (B) output from the STC encoder 1611 of FIG. 4A or 4B according to the control signal.

In step 2507, the selected space-time code stream is converted into an OFDM symbol through an IFFT 1615 and a CP attacher 440, and then transmitted to a corresponding sector. The space-time code streams {Z₁[k], Z₁[k+1]}, . . . , {Z_{M}[k], Z_{M}[k+1]}, output at the M sectors from the selector 1613 through the IFFT 1615 are transmitted through two adjacent subcarriers as shown in FIG. 26. Thereafter, in step 2509, the selection controller 1630 determines if a predetermined update period has arrived. If the update period has arrived, the selection controller 1630 changes a transmission pattern of the space-time code streams in step 2511. The transmission pattern change information is transmitted to each base station through the control signals S₁ to S_{M} which are transmitted to the selectors 1613 next in step 2505. Although the steps 2509 and 2511 follow the step 2507 by way of example, the steps can be performed before the step 2501 or can be simultaneously performed in the step 2505.

Various implementations are possible by reversing output of the space-time code streams (A) and (B) output from each sector and setting a circular pattern of the space-time code streams in a different way. In the SFC-OFDM scheme of FIG. 25, because the space-time encoding is performed every OFDM symbol period, an update period for an output pattern of the space-time code streams can be set to a multiple of the OFDM symbol period.

More specifically, FIG. 26 illustrates a process in which space-time coding is applied every two adjacent subcarriers in the same OFDM symbol before being transmitted, wherein the same space-time encoders are used in different sectors but different space-time code streams are transmitted. Assuming that symbols for broadcast or unicast to be transmitted through N subcarriers in each base station (sector) are defined as X[k], where k=1, 2, . . . , N, and input complex symbols are defined as X[k] and X[k+1], FIG. 26 illustrates a process in which for the space-time coding of FIG. 4A, the base station finds two space-time code streams of {Z₁[k], Z₁[k+1]}={X[k], X[k+1]} and {Z₂[k], Z₂[k+1]}={−X*[k+1], X*[k]} by STC-encoding the input complex symbols through the coding matrix C of Equation (3), and transmits a selected one of the space-time code symbols. One of the space-time code streams is selected per cell or sector by the selection controller 1630 such that the cell/sector diversity gain is maximized.

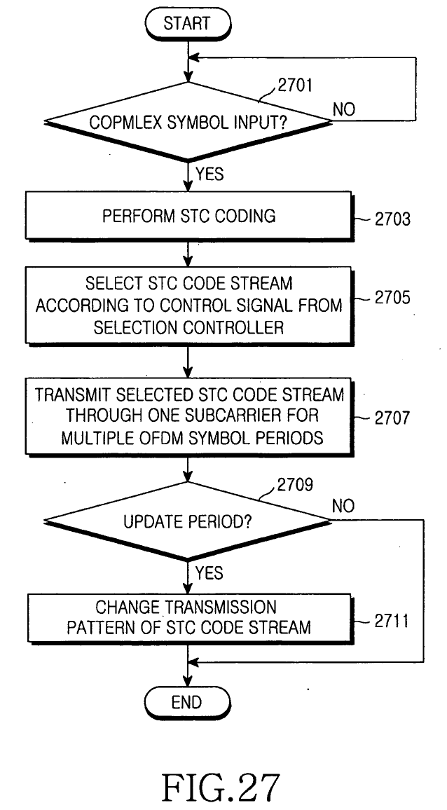

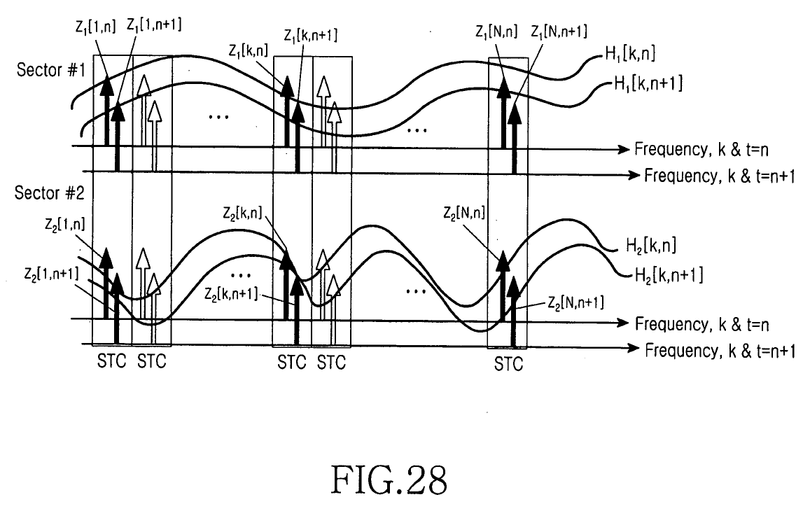

FIG. 27 is a flowchart illustrating an OFDM symbol transmission method based on an STC-OFDM scheme according to the third embodiment of the present invention, and FIG. 28 is a diagram illustrating a process of transmitting space-time code streams in the method of FIG. 27.

Referring to FIG. 27, because steps 2701 and 2703 of STC-encoding multiple complex input symbols according to the Alamouti space-time coding scheme are equal to the steps 2501 and 2503 of FIG. 25, a detailed description thereof will be omitted. However, the complex symbols X(k) and X(k+1) input in step 2501 are arranged through an arrangement buffer (not shown) such that they can be subjected to space-time coding in the space and time domain so that they can be transmitted through the same subcarrier in a 2-OFDM symbol period.

In step 2705, a selection controller 1630 outputs control signals S₁ to S_{M} to their associated selectors 1613 such that the sector patterns of FIGS. 19 to 21 and/or the cell patterns of FIGS. 22 to 24 should be formed, and each of the selectors 1613 receiving their control signals S₁ to S_{M} selects one of two space-time code streams (A) and (B) output from the STC encoder 1611 of FIG. 4A or 4B according to the control signal.

In step 2707, the selected space-time code stream is rearranged through a rearrangement buffer (not shown) such that it can be transmitted through two adjacent OFDM symbols. The rearranged space-time code stream is converted into an OFDM symbol through an IFFT 1615 and a CP attacher 440, and then transmitted to a corresponding sector. The space-time code streams {Z₁[k], Z₁[k+1]}, . . . , {Z_{M}[k], Z_{M}[k+1]}, output at M sectors from the selector 1613 through the IFFT 1615, are transmitted through one subcarrier in a period of two adjacent OFDM symbols as illustrated in FIG. 28.

Thereafter, in step 2709, the selection controller 1630 determines if a predetermined update period has arrived. If the update period has arrived, the selection controller 1630 changes a transmission pattern of the space-time code streams in step 2711. The transmission pattern change information is transmitted to each base station through the control signals S₁ to S_{M} which are transmitted to the selectors 1613 next in step 2705. Although the steps 2709 and 2711 follow the step 2707 by way of example, the steps can be performed before the step 2701 or can be simultaneously performed in the step 2705.

Various implementations are possible by reversing output of the space-time code streams (A) and (B) output from each sector and setting a circular pattern of the space-time code streams in a different way. In the STC-OFDM scheme of FIG. 27, because the space-time encoding is performed every 2-OFDM symbol period, an update period for an output pattern of the space-time code streams can be set to a multiple of the 2-OFDM symbol period.

More specifically, FIG. 28 illustrates a process in which the same space-time encoders are used in different sectors for a period of two adjacent OFDM symbols but different space-time code streams are transmitted using one subcarrier. Assuming that symbols for broadcast or unicast to be transmitted through N subcarriers in each base station are defined as X[k], where k=1, 2, . . . , N, and input complex symbols are defined as X[k, n] and X[k, n+1], FIG. 28 illustrates a process in which for the space-time coding of FIG. 4A, the base station finds two space-time code streams of {Z₁[k, n], Z₁[k, n+1]}={X[k, n], X[k, n+1]} and {Z₂[k, n], Z₂]k, n+1]}={−X*[k, n+1], X [k, n]} by STC-encoding the input complex symbols through the coding matrix C of Equation (3), and transmits a selected one of the space-time code symbols. Herein, ‘n’ denotes a time period for which an OFDM symbol is transmitted. One of the space-time code streams is selected per cell or sector by the selection controller 1630 such that the cell/sector diversity gain is maximized.

Summarizing the novel OFDM symbol transmission scheme, the SFC-OFDM scheme described with reference to FIGS. 13 and 14 performs space-time coding on two adjacent subcarriers, and preferably, the SFC-OFDM scheme is used when there is almost no channel variation between two adjacent subcarriers. The STC-OFDM scheme described with reference to FIGS. 15 and 16 performs space-time coding on two adjacent OFDM symbols, and preferably, the STC-OFDM scheme is used when there is almost no channel variation between two adjacent OFDM symbols.

Finally, it should be noted that because the space-time coding scheme to which the present invention is applied has a coding rate of 1, even though data is received from any one of sectors, the received data can be demodulated without a change in reception performance. Therefore, a base station can perform space-time coding on all subcarriers prior to transmission regardless of transmission of broadcast data or unicast data. A mobile station can receive data in any location within a cell without cell discrimination by applying an STC encoder to all subcarriers, and can obtain an enhanced sector diversity gain compared with the conventional technology, especially in a sector boundary.

As can be understood from the foregoing description, the mobile station can acquire an enhanced sector diversity gain when receiving data from multiple sectors in a sector boundary, thereby increasing the overall cell throughput and an average data rate.

Moreover, space-time code streams transmitted from a base station to its sectors are arranged such that different space-time code streams are arranged for adjacent sectors, thereby further improving a sector diversity gain.

In addition, an output pattern of space-time code streams transmitted from a base station to its sectors or cells is changed every update period on a circular basis, making it possible to obtain a sector diversity gain uniformly improved in a sector/cell boundary.

Furthermore, the present invention is applied to all subcarriers regardless of transmission of broadcast data or unicast data, thereby improving performance of the overall cell throughput with a simple structure.

While the invention has been shown and described with reference to certain embodiments thereof, it will be understood by those skilled in the art that various changes in form and details may be made therein without departing from the spirit and scope of the invention as defined by the appended claims.

1. A method for transmitting by a base station an orthogonal frequency division multiplexing (OFDM) symbol to a mobile station in a wireless mobile communication system with a multicell/multisector structure formed by a plurality of base stations, the method comprising the steps of:
receiving a plurality of complex symbols to be transmitted to the mobile station; and
space-time coding (STC) the plurality of complex symbols and selecting the STC-coded symbols such that different space-time code streams are transmitted to at least one adjacent sector among sectors formed by the base station and other base stations.

2. The method of claim 1, further comprising the step of circulating a transmission pattern of the space-time code streams every predetermined time period.

3. The method of claim 1, wherein the space-time coding step comprises the steps of:
space-time coding the plurality of complex symbols into a plurality of space-time code streams;
selecting one of the plurality of space-time code streams such that different space-time code streams are transmitted to the at least one adjacent sector; and
outputting the selected space-time code stream to a corresponding sector.

4. The method of claim 2, wherein the space-time coding step comprises the steps of:
space-time coding the plurality of complex symbols into a plurality of space-time code streams;
selecting one of the plurality of space-time code streams such that different space-time code streams are transmitted to the at least one adjacent sector; and
outputting the selected space-time code stream to a corresponding sector.

5. The method of claim 3, wherein the selecting step is performed according to the transmission pattern predetermined for each base station.

6. The method of claim 3, wherein the selecting step is controlled by a base station controller connected to the plurality of base stations.

7. The method of claim 1, wherein the number of the sectors formed by the base station is a multiple of 6.

8. The method of claim 2, wherein the base station has a 3-sector coverage.

9. The method of claim 2, wherein the base station forms an omni cell with an omni-directional antenna.

10. The method of claim 1, wherein the selected space-time code stream is transmitted through two adjacent subcarriers using space frequency coding.

11. The method of claim 1, wherein the selected space-time code stream is transmitted through one subcarrier for a period of two adjacent OFDM symbols using space time code.

12. The method of claim 1, wherein the plurality of base stations form a single-frequency network.

13. The method of claim 1, wherein each of the plurality of base stations selects an output space-time code stream according to a predetermined control signal transmitted from an upper layer.

14. The method of claim 2, wherein each of the base stations selects an output space-time code stream according to a control signal transmitted from an upper layer;
wherein the control signal comprises an update period signal of the transmission pattern transmitted from the upper layer, and each of the plurality of base stations generates an update start position signal synchronized to each base station in units of the update period signal.

15. The method of claim 14, wherein the control signal comprises a transmission pattern signal transmitted from the upper layer, and each base station selects an output space-time code stream based on the transmission pattern signal.

16. The method of claim 15, wherein the update start position signal has a period determined as the update period signal, and indicates a start position of the transmission pattern.

17. The method of claim 1, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to an STC encoder.

18. The method of claim 2, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to an STC encoder.

19. The method of claim 1, wherein the STC coding is performed using a Tarokh space-time coding scheme for STC-coding an input symbol into 3 different symbol streams according to a predetermined coding rate, and the predetermined coding rate is ¾.

20. The method of claim 19, wherein the transmission step comprises the step of transmitting the STC-coded symbols at the same time using 4 different adjacent subcarriers in an OFDM symbol.

21. The method of claim 19, wherein the transmission step comprises the step of sequentially transmitting the 4 symbols for a continuous time period using one subcarrier in an OFDM symbol.

22. The method of claim 19, wherein the transmission step comprises the step of sequentially arranges 2 symbols among the STC-coded symbols, transmits the arranged 2 symbols at the same time using 2 adjacent subcarriers in an OFDM symbol, and transmits the remaining 2 symbols at the next broadcast data transmission time using the subcarriers used for transmission of the broadcast data.

23. The method of claim 22, wherein the next broadcast data transmission time continues.

24. The method of claim 22, wherein the next broadcast data transmission time is spaced apart from a previous transmission time by a predetermined time.

25. A base station apparatus for transmitting an orthogonal frequency division multiplexing (OFDM) symbol to a mobile station in a wireless mobile communication system with a multicell/multisector structure formed by a plurality of base stations, the apparatus comprising:
a space-time coding (STC) encoder for space-time coding a plurality of received complex symbols into a plurality of different space-time code streams;
a selector for selecting one of the plurality of space-time code streams such that different space-time code streams are transmitted to at least one adjacent sector from among sectors formed by the base station and/or other base stations; and
a transmitter for transmitting a space-time code stream output from the selector to a wireless network.

26. The bases station apparatus of claim 25, wherein the selector circulates a transmission pattern of the space-time code streams every predetermined time period.

27. The base station apparatus of claim 25, wherein the selector is designed to select the space-time code stream according to the transmission pattern predetermined for each base station.

28. The base station apparatus of claim 26, wherein the selector is designed to select the space-time code stream according to the transmission pattern predetermined for each base station.

29. The base station apparatus of claim 25, wherein the selector is controlled by a base station controller connected to the plurality of base stations.

30. The base station apparatus of claim 26, wherein the selector is controlled by a base station controller connected to the plurality of base stations.

31. The base station apparatus of claim 25, wherein the number of the sectors formed by the base station is a multiple of 6.

32. The base station apparatus of claim 26, wherein the base station has a 3-sector coverage.

33. The base station apparatus of claim 26, wherein the base station forms an omni cell with an omni-directional antenna.

34. The base station apparatus of claim 25, wherein the selected space-time code stream is transmitted through two adjacent subcarriers using space frequency code.

35. The base station apparatus of claim 25, wherein the selected space-time code stream is transmitted through one subcarrier for a period of two adjacent OFDM symbols using space time code.

36. The base station apparatus of claim 25, wherein the plurality of base stations form a single-frequency network.

37. The base station apparatus of claim 25, wherein each of the plurality of base stations selects an output space-time code stream according to a predetermined control signal transmitted from an upper layer.

38. The base station apparatus of claim 26, wherein each of the base stations selects an output space-time code stream according to a control signal transmitted from an upper layer;
wherein the control signal comprises an update period signal of the transmission pattern transmitted from the upper layer, and each of the plurality of base stations generates an update start position signal synchronized to each base station in units of the update period signal.

39. The base station apparatus of claim 38, wherein the control signal comprises a transmission pattern signal transmitted from the upper layer, and each base station selects an output space-time code stream based on the transmission pattern signal.

40. The base station apparatus of claim 38, wherein the update start position signal has a period determined as the update period signal, and indicates a start position of the transmission pattern.

41. The base station apparatus of claim 25, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to the STC encoder.

42. The base station apparatus of claim 26, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to the STC encoder.

43. The base station apparatus of claim 25, wherein the STC coding is performed using a Tarokh space-time coding scheme for STC-coding an input symbol into 3 different symbol streams according to a predetermined coding rate, and the predetermined coding rate is ¾.

44. The base station apparatus of claim 43, wherein the selector controls the transmitter such that the STC-coded symbols are transmitted at the same time using 4 different adjacent subcarriers in an OFDM symbol.

45. The base station apparatus of claim 43, wherein the selector controls the transmitter such that the 4 symbols are sequentially transmitted for a continuous time period using one subcarrier in an OFDM symbol.

46. The base station apparatus of claim 43, wherein the selector controls the transmitter so as to sequentially arrange 2 symbols among the STC-coded symbols, transmit the arranged 2 symbols at the same time using 2 adjacent subcarriers in an OFDM symbol, and transmit the remaining 2 symbols at the next broadcast data transmission time using the subcarriers used for transmission of the broadcast data.

47. The base station apparatus of claim 46, wherein the next broadcast data transmission time continues.

48. The base station apparatus of claim 46, wherein the next broadcast data transmission time is spaced apart from a previous transmission time by a predetermined time.

49. The base station apparatus of claim 43, wherein the selector is controller by a selection controller located in an upper layer of the plurality of base stations.

50. The base station apparatus of claim 49, wherein the selection controller is included in a base station controller.

51. An orthogonal frequency division multiplexing (OFDM) system with a multicell/multisector structure, the system comprising:
a plurality of base stations each comprising;
a space-time coding (STC) encoder for space-time coding a plurality of received complex symbols into a plurality of different space-time code streams, and
a selector for selecting one of the plurality of space-time code streams such that different space-time code streams are transmitted to at least one adjacent sector; and
at least one mobile station for receiving OFDM symbols transmitted from the plurality of base stations and performing diversity combing on the received OFDM symbols.

52. The OFDM system of claim 51, wherein the selector circulates a transmission pattern of the space-time code streams every predetermined time period.

53. The OFDM system of claim 51, wherein the plurality of base stations form a single-frequency network.

54. The OFDM system of claim 51, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to an STC encoder.

55. The OFDM system of claim 52, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to an STC encoder.

56. The OFDM system of claim 51, wherein the STC coding is performed using a Tarokh space-time coding scheme for STC-coding an input symbol into 3 different symbol streams according to a predetermined coding rate, and the predetermined coding rate is ¾.

57. The OFDM system of claim 52, wherein the STC coding is performed using a Tarokh space-time coding scheme for STC-coding an input symbol into 3 different symbol streams according to a predetermined coding rate, and the predetermined coding rate is ¾.
